(19) United States
(12) Patent Application Publication
(10) Pub. No.: US 2025/0130485 A1
(43) Pub. Date: Apr. 24, 2025

(54) PROJECTOR

(71) Applicants: Chengdu BOE Optoelectronics Technology Co., Ltd., Chengdu, Sichuan (CN); BOE TECHNOLOGY GROUP CO., LTD., Beijing (CN)

(72) Inventors: Xiaolong LIU, Beijing (CN); Wei ZHANG, Beijing (CN); Guangquan WANG, Beijing (CN); Tianyang HAN, Beijing (CN); Site CAI, Beijing (CN); Xi LI, Beijing (CN); Yujie WANG, Beijing (CN); Jingang WANG, Beijing (CN); Dalin DONG, Beijing (CN)

(21) Appl. No.: 18/686,804

(22) PCT Filed: Jun. 20, 2022
(86) PCT No.: PCT/CN2022/099977

§ 371 Date: Feb. 26, 2024

(51) Int. Cl. G03B 21/14; G02B 13/16; G02F 1/13357; G03B 21/16; G03B 21/28

(52) U.S. Cl. CPC G03B 21/142; G02B 13/16; G02F 1/1336; G03B 21/147; G03B 21/16; G03B 21/28

(57) ABSTRACT

The present disclosure provides a projector. The projector includes a light source, a display panel, a first lens and a projection lens. The projector is configured such that the light emitted by the light source can sequentially pass through the display panel, the first lens, the projection lens and then exit. The projector includes a system optical axis, and the optical axis of the display panel coincides with the system optical axis; the optical axis of the projection lens is arranged parallel to the system optical axis with a distance therefrom.

### RELATED APPLICATIONS

The present application is a 35 U.S.C. 371 national stage application of PCT International Application No. PCT/CN2022/099977, filed on Jun. 20, 2022, the entire disclosure of which is incorporated herein by reference.

### TECHNICAL FIELD

The present disclosure relates to the display field, in particular to a projector.

### BACKGROUND

A projector is a device that can project images or videos onto a screen, and can be connected to computers, game consoles, TVs and other devices through different interfaces to play corresponding video signals.

Projectors are widely used in homes, offices, schools and entertainment venues. The types of projectors include CRT (Cathode Ray Tube), LCD (Liquid Crystal Display), DLP (Digital Light Processing), 3LCD (3 Liquid Crystal Display) and so on. Single LCD projectors are simple in structure and low in cost, and are suitable for popularization to low and middle level consumer groups, so they have considerable room for growth.

### SUMMARY

The present disclosure provides an LCD projection technology adopting an off-axis (also referred to as “offset axis”) solution, which has no trapezoidal distortion within the projection range of 40-120 inches, and is especially suitable for projection realized by a single LCD. The present disclosure expatiates on the above-mentioned technical solution in terms of theoretical analysis, optical simulation and physical testing. Through specific embodiments, the present disclosure expatiates on the single LCD off-axis scheme, the oblique illumination solution of the lighting system, the position matching of the lighting system and the imaging system, the eccentric arrangement of the front Fresnel lens, and the corresponding projection lens.

The present disclosure provides a projector. The projector includes a light source, a display panel, a first lens and a projection lens; the projector is configured such that the light emitted by the light source can sequentially pass through the display panel, the first lens, the projection lens and then exit; wherein, the projector includes a system optical axis, and an optical axis of the display panel coincides with the system optical axis, an optical axis of the projection lens is arranged parallel to the system optical axis with a distance therefrom.

Optionally, in some embodiments, a center of the projection lens is located at a first position, the system optical axis includes a second position, and a connecting line of the first position and the second position is perpendicular to the system optical axis, wherein a position of the projection lens is configured such that when the center of the projection lens moves from the second position to the first position, a connecting line from a center of a projected picture and the center to the projection lens coincides with the system optical axis.

Optionally, in some embodiments, a distance from a center of a projected picture to the system optical axis is linearly correlated to a distance from the projected picture to the projection lens.

Optionally, in some embodiments, an optical axis of the first lens coincides with the system optical axis; off-axis ratio of a projected picture is

$$Par . 1 = \frac{2 {h}_{1} ( {f}_{1}^{′} + {l}_{1} ) \sqrt{{L}^{2} + {W}^{2}}}{{af}_{1}^{′} W} ,$$

wherein h₁ is the distance between the optical axis of the projection lens and the system optical axis, f′₁ is an image-side focal length of the first lens, −l₁ is an object distance of the display panel relative to the first lens, L is a length of a projected picture, W is a width of the projected picture, and a is a size of a diagonal line of the display area of the display panel.

Optionally, in some embodiments, an optical axis of the first lens is arranged parallel to the system optical axis with a distance therefrom, and the optical axis of the first lens and the optical axis of the projection lens are located on a same side of the system optical axis.

Optionally, in some embodiments, the optical axis of the projection lens, the optical axis of the first lens, and the system optical axis are located on a same plane; the distance from the optical axis of the projection lens to the system optical axis is greater than or equal to the distance from the optical axis of the first lens to the system optical axis.

Optionally, in some embodiments, off-axis ratio of a projected picture is

$$Par . 2 = \frac{2 \sqrt{{L}^{2} + {W}^{2}}}{a W} ( {d}_{1} + \frac{{d}_{2} ( {f}_{1}^{′} + {l}_{1} )}{{f}_{1}^{′}} ) ,$$

wherein d₁ is the distance between the optical axis of the first lens and the system optical axis, d₂ is a difference between the distance from the optical axis of the projection lens to the system optical axis and the distance from the optical axis of the first lens to the system optical axis, f′₁ is an image-side focal length of the first lens, −l₁ is an object distance of the display panel relative to the first lens, L is a length of a projected picture, W is a width of the projected picture, a is a size of a diagonal line of a display area of the display panel. The plane where the projected picture is located is perpendicular to the system optical axis.

Optionally, in some embodiments, h₁ is in a range from −0.3 W_{AA} to 0.3 W_{AA}, wherein W_{AA} is a width of the display panel.

Optionally, in some embodiments, d₁ is in a range from −0.3 W_{AA} to 0.3 W_{AA}, d₂ is in a range from −0.3 W_{AA} to 0.3 W_{AA}, and signs of d₁ and d₂ are the same, wherein W_{AA} is a width of the display panel.

Optionally, in some embodiments, d₁ is in a range from −0.3 W_{AA} to 0.3 W_{AA}, d₂₌₀ mm, wherein W_{AA} is a width of the display panel.

Optionally, in some embodiments, d₁ is in a range from 2 mm to 8 mm.

Optionally, in some embodiments, an optical axis of the light source and the system optical axis form a first angle that is non-zero; the light source is configured such that light propagating along the optical axis of the light source is emitted from a first side of the system optical axis to a second side of the system optical axis; wherein a plane in which the optical axis of the light source and the system optical axis are co-located and a plane in which the system optical axis and the optical axis of the projection lens are co-located are a same plane, and the first side and the second side are respectively two sides of the system optical axis, and the second side is a side where the optical axis of the projection lens is located.

Optionally, in some embodiments, the first angle is −A₁=arctan ((d₁+d₂)/f′₁), wherein d₂ is a difference between the distance of the optical axis of the projection lens and the system optical axis and the distance of the optical axis of the first lens and the system optical axis, f′ is an image-side focal length of the first lens, and −l₁ is an object distance of the display panel relative to the first lens.

Optionally, in some embodiments, light beams emitted by the light source intersect at a first intersection point after passing through the first lens, and a shortest distance between the first intersection point and the system optical axis has a linear relationship with the first angle, and the shortest distance between the first intersection point and the system optical axis increases as the first angle increases.

Optionally, in some embodiments, an angle between a light beam propagation direction along the optical axis of the light source and the system optical axis is in a range from 2° to 7°. Optionally, in some embodiments, the light emitted by the light source is a collimated light beam.

Optionally, in some embodiments, the light source is rotatable, and the optical axis of the light source passes through the center of the display area of the display panel, the light source is configured such that the optical axis of the light source and the system optical axis form the first angle that is non-zero.

Optionally, in some embodiments, the projection lens is liftable, the first lens is adjustable in eccentricity, and the projection lens and the first lens are configured such that the light emitted by the light source can sequentially pass through the display panel, the first lens, the projection lens and then exit.

Optionally, in some embodiments, the first lens is a Fresnel lens, the first lens includes a textured surface with a texture center, the textured surface faces the display panel, and the textured surface is parallel to an extension plane of the display panel; the system optical axis intersects the first lens at a geometric center of the textured surface, and the optical axis of the first lens passes through the texture center; the texture center does not coincide with the geometric center.

Optionally, in some embodiments, a distance between the texture center and the geometric center is in a range from 2 mm to 8 mm.

Optionally, in some embodiments, the projector further includes: a cooling air duct, the cooling air duct is located between the display panel and the first lens, and a width of the cooling air duct is equal to an object distance of the display panel relative to the first lens.

Optionally, in some embodiments, the width of the cooling air duct is in a range from 6 mm to 12 mm.

Optionally, in some embodiments, the display panel is a transparent liquid crystal display panel.

Optionally, in some embodiments, the light source includes a light emitting element and a second lens located on a light emitting side of the light emitting element.

Optionally, in some embodiments, the projector further includes a first reflecting mirror located between the light source and the first lens and configured to reflect light from the light source to the first lens.

Optionally, in some embodiments, the first reflecting mirror has a trapezoidal shape, a short edge of the trapezoidal shape is located on a side of the first reflecting mirror close to the light source, and a long edge of the trapezoidal shape is located on a side of the first reflecting mirror away from the light source.

Optionally, in some embodiments, the projector further includes a second reflecting mirror located between the first lens and the projection lens and configured to reflect light from the first lens to the projection lens.

Optionally, in some embodiments, the second reflecting mirror has a trapezoidal shape, a short edge of the trapezoidal shape is located on a side of the second reflecting mirror close to the first lens, a long edge of the trapezoidal shape is located on a side of the second reflecting mirror away from the first lens, and the distance between the short edge and the long edge is greater than the length of the long edge.

### BRIEF DESCRIPTION OF DRAWINGS

In order to more clearly illustrate the technical solutions in the embodiments of the present disclosure or the prior art, the following will briefly describe the drawings that need to be used in the description of the embodiments or the prior art. Apparently, the drawings in the following description only depict some embodiments of the present disclosure. Those having ordinary skills in the art can also obtain other drawings according to these drawings without creative efforts.

FIG. 1 shows the principle diagram of the imaging optical path of a single LCD projector in the related art;

FIG. 2 shows the schematic structural diagram of a single LCD projector in the related art;

FIG. 3 is the schematic diagram of an object-side telecentric optical path;

FIG. 4 shows the embodiments with off-axis ratios of 0%, 50% and 100%, respectively;

FIG. 5 is the schematic diagram of the off-axis projection solution A;

FIG. 6 is the schematic diagram of the off-axis projection solution B;

FIG. 7 shows the schematic structural diagram of a projector provided according to an embodiment of the present disclosure;

FIG. 8 shows the schematic structural diagram of a projector provided according to another embodiment of the present disclosure;

FIG. 9 is the structural diagram showing that the optical axis of the projection lens is off-axis from the central axis of the display area;

FIG. 10 is the schematic diagram of the imaging of the center of the display area with the lens not off-axis;

FIG. 11 shows the size and shape of the projected picture on the screen;

FIG. 12 shows the offset of the projected picture;

FIG. 13 shows the exploded schematic diagram of a single LCD projector along the optical path;

FIG. 14 is the three-dimensional layout diagram of the aperture diaphragm;

FIG. 15 is the schematic diagram of the intersection point of the chief rays in the image-side telecentric optical path;

FIG. 16 is the schematic diagram of the original non-chief rays;

FIG. 17 is the schematic diagram of the imaging of the rays from the center of the display area when the lighting system is performing perpendicular illumination;

FIG. 18 is the schematic diagram of ray trajectories when the lighting system is performing perpendicular illumination;

FIG. 19 is the relative light utilization rate when the lighting system is performing perpendicular illumination;

FIG. 20 shows the light spot when the lighting system is performing perpendicular illumination;

FIG. 21 is the schematic diagram of parallel rays illuminating obliquely at an angle of −5°;

FIG. 22 shows the schematic diagram of oblique illumination of parallel rays;

FIG. 23 is the schematic diagram of oblique illumination of the lighting system;

FIG. 24 is the schematic diagram of ray trajectories of oblique illumination of the lighting system;

FIG. 25 is the detailed schematic diagram of an LCD being illuminated obliquely by the rays from an actual light source;

FIG. 26 shows the relative light utilization rate of the lighting system for oblique illumination;

FIG. 27 shows the light spot on the screen when the lighting system is performing oblique illumination;

FIG. 28 shows the luminous flux received by the screen when the lighting system is performing oblique illumination;

FIG. 29 shows the structural changes of the plano-convex lens and the Fresnel lens;

FIG. 30 shows the intersection points on the Fresnel lens under different oblique illumination angles;

FIG. 31 shows the relationship between the eccentricity of the front Fresnel lens and the intersection point offset of the Fresnel lens under different oblique illumination angles;

FIG. 32 shows the relationship between the lighting system deflection angle −A₁ and the Fresnel lens intersection point offset h₂ under different eccentricities of the front Fresnel lens;

FIG. 33 shows the position matching of the lighting system and the imaging system;

FIG. 34 shows that the eccentricity used by the front Fresnel lens is adjustable;

FIG. 35 is the 2D schematic diagram of an eccentric Fresnel lens;

FIG. 36 is the schematic diagram of eccentric imaging of the front Fresnel lens;

FIG. 37 shows the model in which the conditions include perpendicular illumination and an eccentricity of 6 mm for the front Fresnel lens;

FIG. 38 shows another model, the conditions of which include oblique illumination of 2.7° and an eccentricity of 6 mm for the front Fresnel lens;

FIG. 39 is the schematic structural diagram of a lens suitable for an embodiment of the present disclosure;

FIG. 40 shows the optical path of a horizontal projector and the optical path of a perpendicular projector;

FIG. 41 shows the schematic diagram of calculating an oblique illumination angle;

FIG. 42 shows the schematic diagram of an ideal two-optical group imaging; and

FIG. 43 is the schematic diagram showing the tendency of rays to converge before reaching the aperture diaphragm.

### DETAILED DESCRIPTION OF EMBODIMENTS

The technical solutions in the embodiments of the present disclosure will be clearly and completely described hereinafter in conjunction with the drawings in the embodiments of the present disclosure. Apparently, the described embodiments are only some of the embodiments of the present disclosure, not all of them. Based on the embodiments in the present disclosure, all other embodiments obtained by those having ordinary skills in the art without making creative efforts fall within the protection scope of the present disclosure.

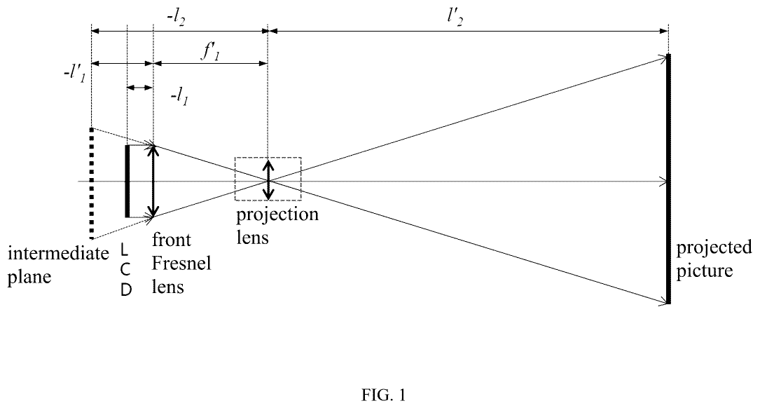

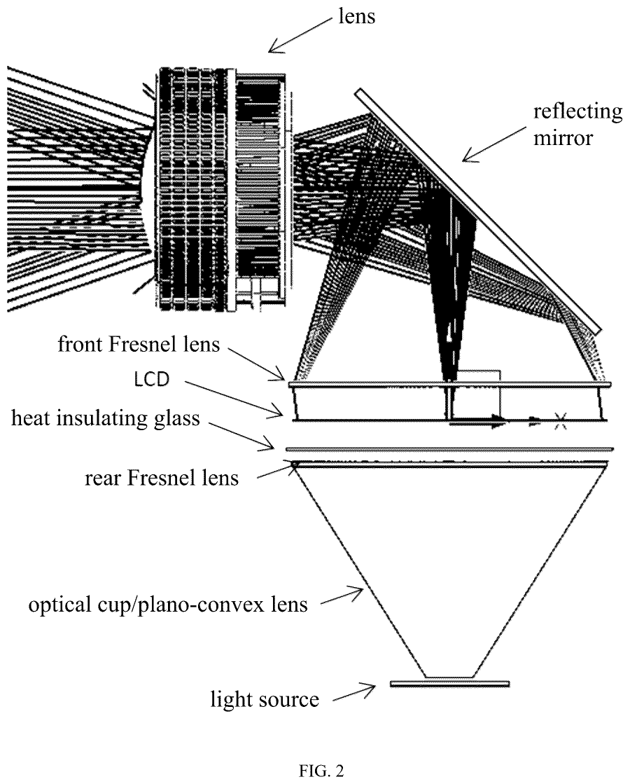

FIG. 1 shows the principle diagram of the imaging optical path of a single LCD projector in the related art. FIG. 2 shows the imaging optical path of a single LCD projector in the related art. In a single LCD projector, the LCD is imaged twice and projected on the projection screen to form the projected picture. In the first imaging: the LCD is the object, the front Fresnel lens is the lens, and the intermediate plane is the image. In the second imaging: the intermediate plane is used as the object, the projection lens is used the imaging lens, and the projected picture is the image.

In the context of the present disclosure, the signs of parameters in optical paths follow the following sign rules. Positive direction: the direction of ray propagation is the positive direction, usually from left to right. Parameters relating to a line: selecting a reference point on an optical axis (such as vertex, principal point, focal point, etc.), the left side of the reference point is negative, and the right side of the reference point is positive. The distance from an off-axis point to an optical axis, the point above the axis is positive, and the point below the axis is negative. Parameters relating to an angle: an angle is typically composed of an optical axis, a ray, and a normal line. The optical axis rotates first, the ray follows, and the normal line does not rotate. The angle is always less than or equal to 90°. The angle formed by clockwise rotation is positive, and the angle formed by counterclockwise rotation is negative. Optical axis: when rays pass through an imaging system, they are rotationally symmetric about an axis; therefore, an optical axis is a common axis that passes through the curvature center of the surface of each optical element. Such an imaging system is referred to as a coaxial optical system. The system described in the present disclosure is a non-coaxial system, mainly including three optical axes: the normal line passing through the center of the LCD display area (also referred to as the AA area, the effective area), the normal line passing through the Fresnel center of the Fresnel lens, and the optical axis of the projection lens. In the context of the present disclosure, the system optical axis may be defined as the normal line passing through the center of the display area. Those having ordinary skills in the art can understand that when the imaging optical path of a projector includes a reflecting mirror, the system optical axis is deemed as the normal line passing through the center of the display area, and the system optical axis follows the reflection law relative to the reflecting mirror. For example, in the embodiments shown in FIG. 8 and FIGS. 16-18, the system optical axis may be a polygonal line that follows the reflection law relative to the reflecting mirror, instead of a straight line.

A single LCD projector has to go through two imaging processes, mainly because the size of the LCD is typically large, and the light beam needs to be converged by the front Fresnel lens first, so that more rays can pass through the projection lens. For example, when the size of the LCD is 4.45 inches, the object height H=4.45*25.4/2=56.515 mm, which is usually larger than the diameter of the projection lens. If there is no front Fresnel lens, most of the rays emitted by the LCD, especially the rays with a large off-axis amount and a large aperture angle, cannot pass through the lens aperture diaphragm. Not only can a lot of light not enter the lens, but the rays that enter the lens may also produce severe vignetting (high brightness in the central portion of the picture and low brightness at the edges). When the front Fresnel lens is used, the rays emitted by various object points on the LCD (especially those rays parallel to the optical axis) are focused and pass through the center of the aperture diaphragm to ensure that each object point has a sufficiently high brightness.

In the first imaging, there is such an object-image relationship: the LCD is the object being imaged, the front Fresnel lens is the imaging lens, and the intermediate plane is the virtual image of the LCD (because the image point is not the point where the rays converge, but the intersection point of the reverse extension lines of the actual rays). The imaging equation of a thin lens is:

$$\frac{1}{{l}_{1}^{′}} - \frac{1}{{l}_{1}} = \frac{1}{{f}_{1}^{′}} \qquad Eq . 1$$

wherein, −l₁ represents the object distance of the LCD, and its sign follows the sign rules; −l′ represents the image distance of the intermediate plane, and its sign follows the sign rules; f′₁ represents the image-side focal length of the Fresnel lens, and its sign follows the sign rules (the lens used is a positive lens, and the image-side focal length is always a positive value).

In the second imaging, there is such an object-image relationship: the intermediate plane is the object being imaged (virtual object), the projection lens is the imaging lens, and the projected picture is the real image of the intermediate plane (because it is the points where the actual rays converge). According to the imaging equation (Newton's formula) of an ideal optical system:

$$\frac{{f}_{2}^{′}}{{l}_{2}^{′}} + \frac{{f}_{2}}{{l}_{2}} = 1 \qquad Eq . 2$$

wherein, −l₂ represents the object distance of the intermediate plane, and its sign follows the sign rules; l₂ represents the image distance of the projected picture, and its sign follows the sign rules; f′₂ represents the image-side focal length of the lens; f′₂ represents the object-side focal length of the lens; since both ends of the lens are in the air medium, according to the equation of focal power:

$$- {f}_{2} = {f}_{2}^{′} \qquad Eq . 3$$

an imaging equation similar to that of a thin lens can be obtained:

$$\frac{1}{{l}_{2}^{′}} - \frac{1}{{l}_{2}} = \frac{1}{{f}_{2}^{′}} \qquad Eq . 4$$

In order to calculate the imaging optical path, the distance between the front Fresnel lens and the LCD is preset as −l₁=10, and the focal length of the front Fresnel lens is preset as f′₁=125. According to the thin lens imaging equation, the image distance can be calculated as −l₁=−10.87, so the magnification of the front Fresnel lens is β₁=l′₁/l₁=1.087. The total magnification of the optical path is β=−60/4.45=−13.483. Therefore, the magnification of the projection lens is β₂=β/β₁=−12.404. According to the projection size of 60 inches and the projection ratio of 16:9, the width of the projected picture is 2 h₃=1328 mm. The transmittance is 1.28, and according to its definition: l′₂=1700, R=l′₂/(2 h₃). According to the magnification of the lens, it can be deduced: l₂=−l′₂/β₂=−137.03. According to the imaging equation, the focal length of the lens can be calculated as:

$$\frac{1}{{l}_{2}^{′}} - \frac{1}{{l}_{2}} = \frac{1}{{f}_{2}^{′}} ,$$

f′₂=126.81.

It can be seen from the above calculation that β₁>0, so the first imaging obtains an upright image. β₂<0, so the second imaging obtains an inverted image.

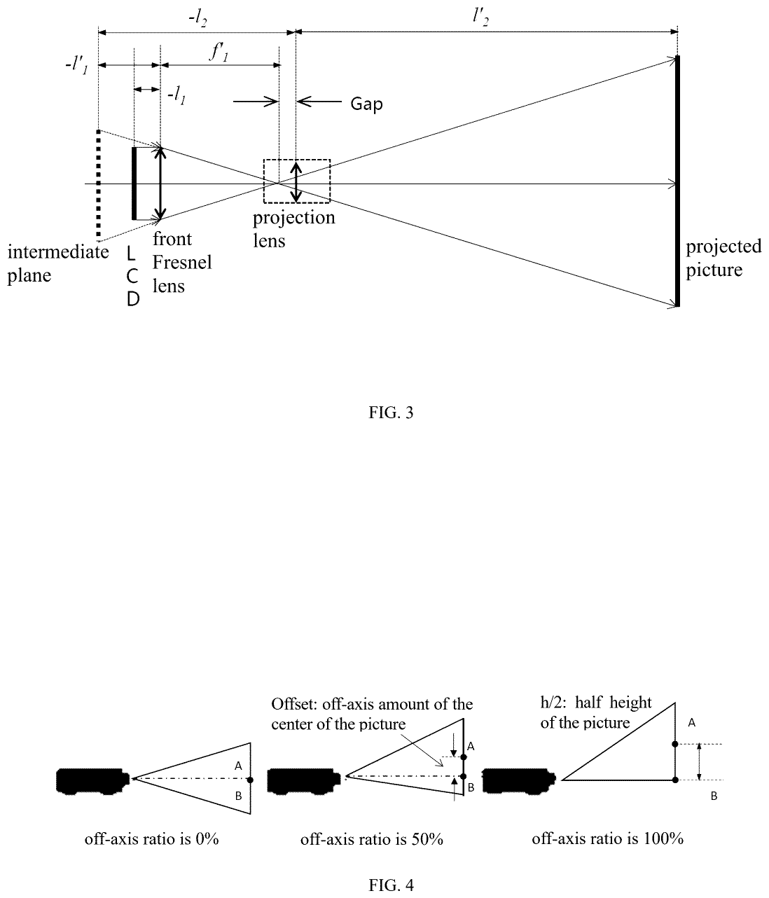

The calculation of the above parameters requires a further checking process (selecting the appropriate focal length of the front Fresnel lens and the focal length of the lens for fine-tuning), that is, to confirm whether it is the object-side telecentric optical path, as shown in FIG. 3.

In the art, the object-side telecentric optical path means that the object-side image of the aperture diaphragm (i.e., the “pupil”) is at infinity in the object side. This means that the rays emitted from infinity in the object side (that is, the rays parallel to the optical axis) can pass through the center of the aperture diaphragm (the rays emitted by the lighting system in the main direction pass through the center of the aperture diaphragm, and are less blocked by the aperture diaphragm, so the vignetting phenomenon is slight, the light utilization rate is high, and the brightness of the projected picture is high). Generally speaking, the aperture diaphragm refers to an aperture diaphragm of the entire imaging system (including the front Fresnel lens), but here it refers to the aperture diaphragm of the projection lens. Because the aperture diaphragm of the projection lens plays a major role in limiting the aperture angle of a ray, the front Fresnel lens does not limit the aperture angle of a ray (otherwise the light utilization rate will be lower).

To sum up, in FIG. 3, for an ideal telecentric optical path, the telecentric gap (Gap) is equal to zero, that is, the focal point of the front Fresnel lens coincides with the center of the aperture diaphragm of the projection lens. In an actual optical path, this gap is often not equal to zero, but close to zero. This is because the focal length of a commonly used Fresnel lens is generally an integer multiple of 5, such as 115 mm, 120 mm, 125 mm, 130 mm and the like. When selecting the focal length of the front Fresnel lens, an appropriate focal length may be selected so that the above gap is as close to zero as possible.

$$G a p = - {l}_{2} - ( - {l}_{1}^{′} - {f}_{1}^{′} ) \qquad Eq . 5$$

TABLE 1
Telecentric gaps at different focal lengths of the
front Fresnel lens (front Fresnel focal length)

| front Fresnel focal length | focal length of the projection lens | Gap |
|---|---|---|
| 115 | 127.7 | 12.13 |
| 120 | 127.24 | 6.62 |
| 125 | 126.81 | 1.16 |
| 130 | 126.42 | −4.26 |
| 135 | 126.06 | −9.6 |

As shown in Table 1, for the Fresnel lenses with different focal lengths, when the focal length is 125 mm, the telecentric gap (Gap) is closest to 0. When performing optical simulations and physical verifications, the focal length of the front Fresnel lens may be set as 125 mm.

It should be noted that in the simulation, the object side and image side of the imaging optical path are reversed to that in the actual situation. That is, the projected picture is an object, and the LCD is an image. The main considerations for doing so are as follows: the size of the LCD is constant, but the size of the projected picture is variable, such as 40 to 100 inches. The reversed optical path can keep the image height (that is, the field of view) unchanged, instead of adjusting the field of view and greatly modifying the simulation model every time the size of the projected picture changes.

Therefore, in the simulation, the previous “object-side telecentric optical path” has been changed to be the “image-side telecentric optical path”, and the previously required “entrance pupil center is at object-side infinity” has become “exit pupil center is at object-side infinity”. The “exit pupil” is the image of the aperture diaphragm in the image space. Since the optical path is reversible, the rays do not change substantially when performing analysis before and after reversing the object space and the image space.

In the simulation, the model is generally automatically optimized to be the “image-side telecentric optical path”. If the model gives wrong results, the designer will lock the focal length of the front Fresnel lens (such as 125 mm) and then perform optimization. Finally, it is determined whether the telecentric condition is satisfied by checking the value of the operand “exit pupil position (EXPP)”. Generally, the absolute value of this value is required to be 100 times greater than the diameter of the pupil, or greater than a few thousand. At this time, the angle between the ray in the main direction and the chief ray is very small, and they can basically pass through the center of the aperture diaphragm to achieve a higher utilization rate.

Off-axis projection is one of the important functions of a projector. In a projection system, the center of the picture can be set as point A, and the intersection point of the normal line of the screen passing through the optical center of the lens and the screen is point B. When two points A and B coincide, it is non-off-axis projection (off-axis ratio is 0%). When two points A and B do not coincide, it is an off-axis projection. The distance between A and B is referred to as “Offset”. Generally, in practice, the focus is on the off-axis projection in the height direction, and the “off-axis ratio” (Par., that is, Partial axial ratio) can be defined as the ratio of Offset to the half-height of the picture, that is:

$$Par . = \frac{Offset}{h / 2} \qquad Eq . 6$$

FIG. 4 shows the embodiments in which the off-axis ratios are 0%, 50%, and 100%, respectively.

There are two solutions to achieve off-axis: one is off-axis projection solution A by changing the ray deflection direction, and the other is off-axis projection solution B by changing the position of the imaging element.

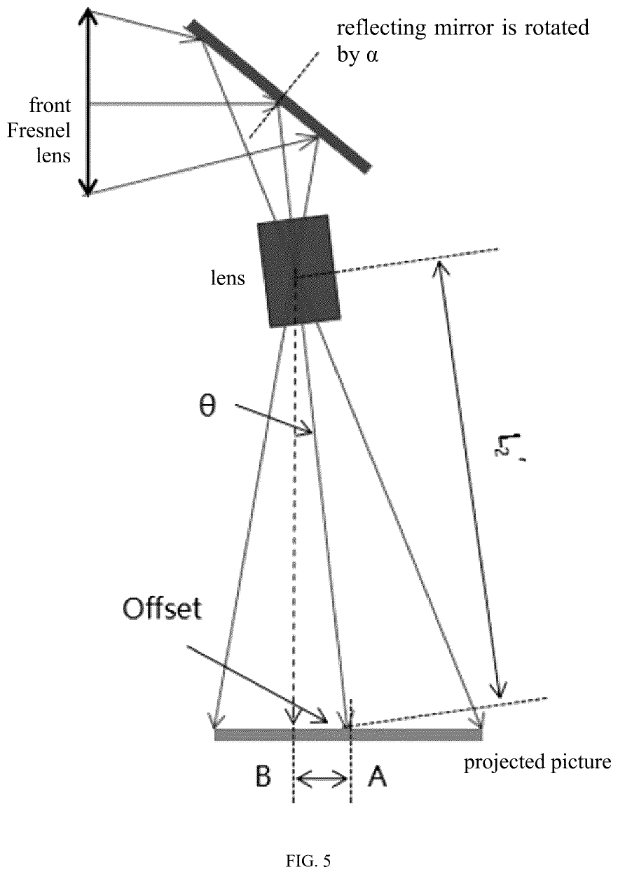

FIG. 5 is a schematic diagram of off-axis projection solution A. In off-axis projection solution A, when performing non-off-axis projection, the angle between the normal line of the reflecting mirror and the normal direction of the screen is 45°, and the rays emitted from the center of the front Fresnel lens pass through the optical axis of the lens after being reflected by the reflecting mirror (at this time, the optical axis of the lens is perpendicular to the normal direction of the screen), and perpendicularly illuminate the screen. At this time, point A coincides with point B, and the off-axis ratio is 0. When the reflecting mirror is rotated by an angle α (such as being rotated counterclockwise), the rays emitted from the center of the front Fresnel lens are reflected by the reflecting mirror, then pass through the optical axis of the lens (at this time, the angle between the optical axis of the lens and the normal direction of the screen is 0), and obliquely illuminate the screen. Two points A and B do not coincide at this time. The projector can also use no reflecting mirror, but a height-adjustable support leg is set at the bottom of the projector to realize oblique projection. The effect of rotating the projection lens can also be achieved by turning the projector at an angle as a whole. In principle, a flat reflecting mirror is an ideal optical imaging device, which only changes the direction of light propagation without changing the magnification and image quality of the system. The overall effect of using the support leg to adjust the inclination angle and using the flat reflecting mirror to adjust the inclination angle is to make the lens have an elevation angle, so there is no essential difference between using the support leg to adjust the inclination angle and using the flat reflecting mirror to adjust the inclination angle, and both can be regarded as off-axis projection solution A. The advantages of off-axis projection solution A include: the actual object height participating in the imaging does not increase, and the lens is easy to design. The disadvantages of off-axis projection solution A include: the angle between the lens optical axis and the normal direction of the screen is θ, and the image plane is perpendicular to the lens optical axis, so the angle between the image plane and the screen is θ, which may cause trapezoidal distortion. Optical correction or electronic correction is required, so that some image quality may be sacrificed.

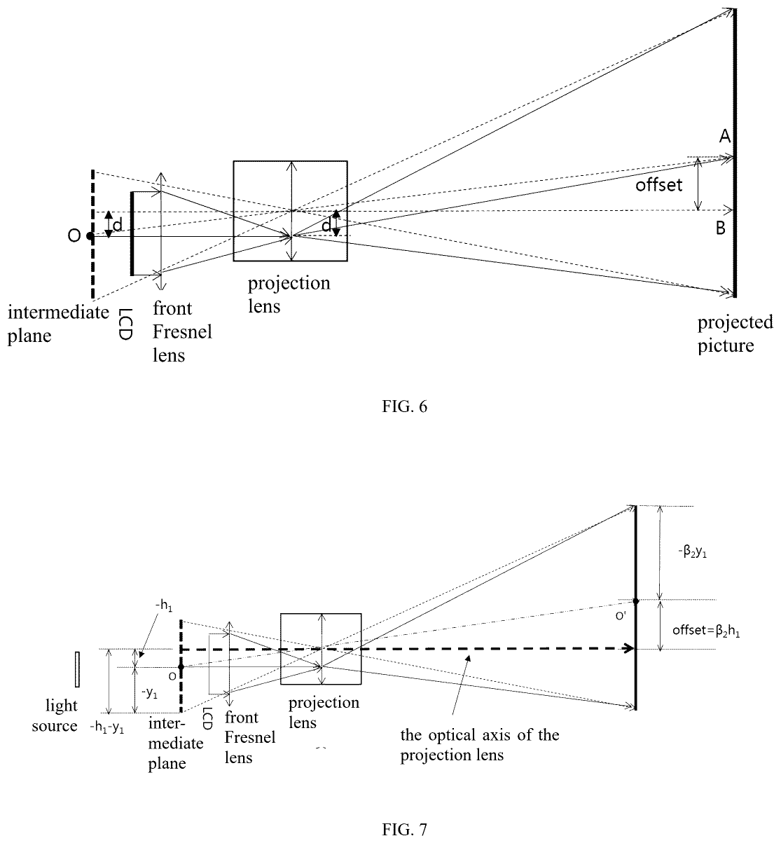

FIG. 6 is a schematic diagram of off-axis projection solution B. When performing non-off-axis projection, the optical axis of the projection lens and the optical axis of the front Fresnel lens are coaxial, that is, lens lift height d=0. At this time, the rays emitted from the center of the front Fresnel lens pass through the optical axis of the lens and perpendicularly illuminate the screen. Point A coincides with point B, and the off-axis ratio is 0. In off-axis projection solution B, when lens lift height d>0, the object height of the virtual image (the intermediate plane) of the LCD increases by −d relative to the optical axis of the lens. Relative to the optical axis of the lens, the object height of the virtual image center O is −d. If the magnification of the lens is β, the height of point A at this time is: −dβ (for the sign rules, refer to the previous description). Point A is the center of the picture, and point B is the intersection point of the normal line of the screen passing through the optical center of the lens and the screen. According to the definition, −dβ is equal to Offset.

The object-image relationship of the off-axis optical path is identical to that of the coaxial optical path, but may cause greater aberrations. First of all, “aberration” refers to the difference in imaging quality between an actual optical system and an ideal optical system, which can be divided into: spherical aberration, coma aberration, astigmatism, field curvature, distortion, chromatic spherical aberration and chromatic aberration of magnification. When analyzing the imaging performance of an actual optical system, it can be divided into two steps: the first step is to analyze the imaging laws of an ideal optical system, and the second step is to analyze the aberrations of an actual optical system. Secondly, for an ideal optical system, it is usually only necessary to know its base points and base planes to fully describe its imaging laws. The base points refer to: principal point, focal point, node. Base planes refer to: principal point plane, focal plane, and nodal plane. The principal point planes refer to the planes where the object point and image point are located when the object height is equal to the image height. The intersection points of the principal point planes and the optical axis are an object-side principal point and an image-side principal point, respectively. The focal plane refers to the plane passing through the focal point when the focal point of the optical system can be confirmed by a parallel light test. The node refers to: the incident ray of any aperture angle pointing to a certain point on the axis, the aperture angle remains unchanged after leaving the system (that is, the angular magnification is equal to 1), and this special point is the node of the optical system. When the object space and the image space of the system are in the same medium, the principal point coincides with the node.

An optical group refers to an optical system that includes at least two refractive interfaces, for example, a thin lens has two refractive spherical surfaces. Therefore, a Fresnel lens can be regarded as an optical group. Apparently, a projection lens is another optical group.

The object-image relationships of an off-axis optical path and a coaxial optical path are the same. The optical axes of a coaxial system are collinear, and the image quality satisfies the characteristics of rotational symmetry. Typically, the optical axes of an off-axis system are parallel but not collinear, and the image quality does not satisfy rotational symmetry. If the two optical groups are regarded as an ideal imaging system, when compared with the coaxial system, the positions of its base point planes do not change. This means that the imaging relationships (calculations) described above are applicable for off-axis imaging.

It should be noted that the above two optical groups respectively represent the front Fresnel lens and the projection lens—the off-axis here means that the front Fresnel lens and the projection lens are not coaxial. If the front Fresnel lens is an eccentric Fresnel lens, and its optical axis and the optical axis of the lens are raised by the same height relative to the system optical axis, and thus are collinear, such a system does not have an off-axis optical path—it is only equivalent to the situation where the position of the LCD as an “object” decreases, that is, the “object height” increases.

The advantages of off-axis projection solution B include: the off-axis amount is equal to the increase of object height, the object-image plane is not tilted, and no trapezoidal distortion occurs. The disadvantages of off-axis projection scheme B include: the off-axis amount is equal to the increase of object height, and the lens design is difficult, including: the field of view increases, the edge image quality is difficult to be guaranteed, and the relative illuminance is not easy to improve. Another important disadvantage is that the chief rays do not pass through the center of the aperture diaphragm, which will cause heavy vignetting and uneven brightness in the projected picture.

The inventor has noticed that the off-axis amount is equal to the increase of the object height, so it is required to design a lens that supports a larger object height (or “field of view”). In order to ensure image quality and relative illuminance, at least one of the following methods can be adopted: (1) using optical glass with a higher refractive index; (2) appropriately relaxing the projection ratio, resolution, etc.; (3) using more lens pieces; (4) using an aspheric lens to correct peripheral aberrations and so on. In the embodiments of the present disclosure, methods (1) and (2) are adopted, specifically: La-series glass with a high refractive index (refractive index>1.7) is used to replace ordinary ZK series glass (refractive index is about 1.6); the projection ratio is changed from 1.25 to 1.28.

In order to solve the problem that “the chief rays do not pass through the center of the aperture diaphragm, causing heavy vignetting and uneven brightness in the projected picture”, the inventor has proposed to cooperatively apply the technical solutions such as “oblique illumination of the lighting system” and “eccentricity of the front Fresnel lens” into the projector.

The reason why raising the optical axis can follow the imaging law can be explained as follows. First, an actual imaging system is the result of an ideal imaging system when aberrations are considered. Aberrations can be corrected during the design of optical path elements and the design of lenses. Therefore, the principle of realizing off-axis can be explained by an ideal optical system. The characteristics of an ideal optical system are: a point forms a point image. There is a one-to-one correspondence between object points and image points, and there is no diffuse spot. A line forms a line image. There is a one-to-one correspondence between straight lines and straight line images without distortion. A plane forms a plane image. There is a one-to-one correspondence between planes and plane images without bending. The axes of symmetry are conjugate. On the sagittal plane, the point A is rotated by an angle α around the optical axis of the object space, and the image point A′ is also rotated by an angle α around the optical axis of the image space.

Therefore, although the optical axis of the lens is raised, the base point plane and the object-image plane of the system are not changed, nor is the magnification changed. Only the image height on the image plane has been changed—finally reflected in the change of the overall height of the picture, that is, the change of the height of the center of the picture, which is off-axis projection.

In the related art, no single LCD projector has adopted solution B to realize off-axis projection. This is mainly due to the following reasons. This technology has a large imaging field of view, and needs to ensure high brightness, high uniformity, and the projection ratio should not be too large, so it is difficult to develop. The light utilization rate is low, and the picture uniformity is poor.

“Projection ratio” refers to the ratio of a projection distance to the width of a projected picture. The smaller the projection ratio, the shorter the focal length of the imaging system, which makes it more difficult to design the lens under the same imaging quality requirements.

The technical specifications realized by the disclosure are shown in Table 2.

TABLE 2

| | | Demo measurement | |
|---|---|---|---|
| Item | Specifications | results | Comments |
| Display area | 4.45 inches, 16:9 | — | |
| size | | | |
| Off-axis ratio | 50%, ±5% | 55% | Off-axis |
| | | | without |
| | | | trapezoidal |
| | | | distortion |
| Projection | 1.28 ± 6% | 1.28 | @60 inches, |
| ratio | | | better than most |
| | | | similar products |
| Brightness | Typ. 200 Lm | 206 Lm | |
| Uniformity | Typ. 65% | 61% | @60 inches |
| Color Gamut | Typ. 60% NTSC | 56% | higher than |
| | | | most similar |
| | | | products |
| Projection | 40-120 inches | 40-120 inches | |
| size | | | |
| Resolution | center pixel trailing < 3 mm, | center pixel trailing < 2.5 mm, | using grid test |
| | edge pixel trailing < 5 mm | edge pixel trailing < 4.8 mm | |
| Distortion | TV distortions in vertical | H: 0.61%, V: 0.54% | |
| | and horizontal | | |
| | directions < 0.8% | | |

In the single LCD projector products in the related art, there is no product that can achieve 50% off-axis without trapezoidal distortion. The present disclosure proposes an off-axis solution without trapezoidal distortion, which is realized by adopting a solution in which the optical elements such as lenses are off-axis.

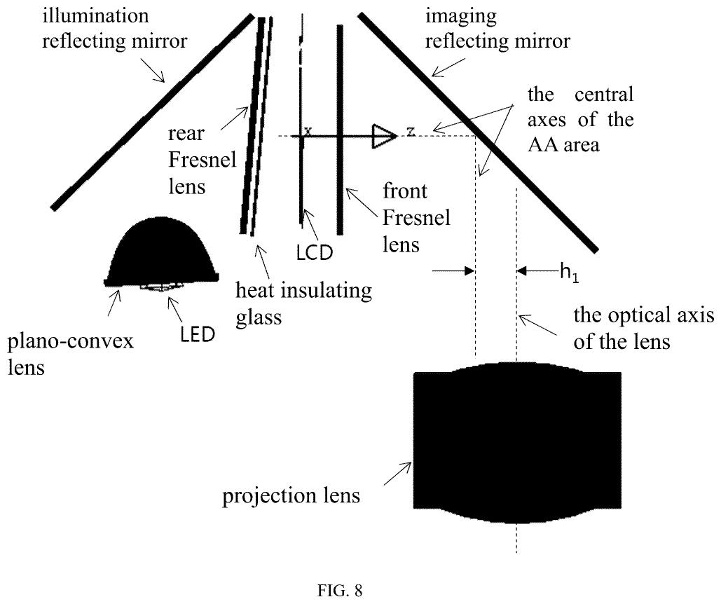

In an embodiment of the present disclosure, the projection lens has an off-axis amount relative to the system optical axis. Specifically, the optical axis of the projection lens is raised by h relative to the system optical axis. FIGS. 7 and 8 illustrate the projectors provided by the embodiments of the present disclosure. The difference between FIG. 8 and FIG. 7 is mainly that the projector shown in FIG. 8 includes a reflecting mirror, so the two embodiments are substantially the same. As shown in FIGS. 7 and 8, the projector includes a light source, a display panel (LCD), a first lens, and a projection lens; the projector is configured such that the light emitted by the light source can sequentially pass through the display panel, the first lens, the projection lens and then exit; wherein, the projector includes a system optical axis, and the optical axis of the display panel coincides with the system optical axis; the optical axis of the projection lens is arranged in parallel to the system optical axis with a distance therefrom.

As shown in FIG. 8, the light source includes a light emitting element (LED), a plano-convex lens, an illumination reflecting mirror, and a second lens (rear Fresnel, i.e. a rear Fresnel lens). The plano-convex lens and the second lens provide a light beam shaping function (i.e. collimation function). Thus, the half-angle of divergence of the light beam emitted from the light source may be smaller than the FOV of the imaging system, and the half-angle of divergence may be, for example, 8.5°.

In an embodiment of the present disclosure, a Fresnel lens can be used as the first lens. As shown in FIG. 7 and FIG. 8, a front Fresnel lens (also referred to as a “front Fresnel”) is arranged between the LCD and the projection lens. In the present disclosure, only Fresnel lenses are taken as an example to describe related embodiments. Those having ordinary skills in the art can understand that other optical lenses (such as but not limited to, a single convex lens, a single plano-convex lens, and their combinations) with converging or imaging functions can also be used as the “first lens” in the embodiment of the present disclosure and the “second lens” described hereinafter. Specifically, at least one of the “first lens” and the “second lens” may be an aspheric lens. The distance between the optical axis of the projection lens and the system optical axis is h₁.

In this embodiment, the front Fresnel lens can be arranged in two ways. In the first case, the front Fresnel lens is centered, and the optical axis of the front Fresnel lens is collinear with the normal line passing through the center of the display area. FIG. 6 shows the imaging principle of this solution. Assume that the projection lens is raised by a height of h₁, the size of the LCD display area is a inches, the size of the projected picture is b inches, and the length to width ratio is L/W.

In this case, the magnification of the system is:

$$β = - \frac{b}{a} \qquad Eq . 7$$

Since the system forms an inverted image, β<0.

The magnification of the front Fresnel lens is:

$${β}_{1} = \frac{{l}_{1}^{′}}{{l}_{1}} \qquad Eq . 8$$

−l₁ represents the gap between the LCD and the front Fresnel lens, which is generally used as a cooling air duct. The width of the cooling air duct is typically preset as 6-12 mm. l′₁ represents the position of the virtual image plane, calculated by the focal length of the Fresnel lens, referring to Eq. 1. Optionally, in some embodiments, the projector further includes: a cooling air duct, the cooling air duct is located between the display panel and the first lens, and the width of the cooling air duct is equal to the object distance of the display panel relative to the first lens. Optionally, the width of the cooling air duct is in the range of 6-12 mm.

Optionally, in some embodiments, the display panel is a transparent liquid crystal display panel, that is, a transparent LCD.

The focal length of the Fresnel lens is also a preset value, which can be considered as a known value. It will be corrected later when the telecentric gap (Gap) is verified, referring to Eq. and Table 1. It can be deduced from them that:

$${β}_{1} = \frac{{f}_{1}^{′}}{{f}_{1}^{′} + {l}_{1}} \qquad Eq . 9$$

Therefore, the magnification to the projection lens can be calculated as:

$${β}_{2} = \frac{β}{{β}_{1}} \qquad Eq . 10$$

$${β}_{2} = - \frac{b ( {f}_{1}^{′} + {l}_{1} )}{{af}_{1}^{′}} \qquad Eq . 11$$

In the first imaging, the position of the intermediate plane is unchanged, when compared to the coaxial system. The height of the lens is raised by h₁ in the second imaging. This is equivalent to increasing the object height of the intermediate plane by h₁, or lowering the center of the picture by h₁. FIG. 7 shows the change of object height and image height in the second imaging.

Before the lens is raised (that is, the optical path corresponding to FIG. 1), the object height of the intermediate plane relative to the lens is −y₁, the object height of the center of the intermediate plane relative to the lens is 0, the image height of the intermediate plane at the projected picture is −β₂y₁, the image height of the center of the intermediate plane at the projected picture is 0. At this time, offset=0.

After the lens is raised (that is, the optical path shown in FIG. 7), the object height of the intermediate plane relative to the lens is −h₁−y₁, the object height of the center O of the intermediate plane relative to the lens is −h₁, and the image height of the intermediate plane at the projected picture is −β₂(h₁+y₁), the image height of the center O′ of the intermediate plane at the projected picture is −β₂ h₁. At this time:

$$offset = - {β}_{2} {h}_{1} \qquad Eq . 12$$

It should be noted that: B represents the lateral magnification, and its physical meaning is the ratio of image height to object height (definition equation), that is:

$$β = \frac{{y}^{′}}{y} \qquad Eq . 13$$

When β<0, y′ and y have different signs, which means forming an inverted image; when β>0, y′ and y have the same sign, which means forming an upright image.

When |β|<1, it means forming a reduced image; when |β|>1, it means forming an enlarged image.

From Eq. 6 (definition of off-axis ratio), it can be seen that the half-height to the projected picture needs to be calculated first. The size of the projected picture is b inches, and the length to width ratio is L/W, then it can be calculated as:

$$h = \frac{b W}{\sqrt{{L}^{2} + {W}^{2}}} \qquad Eq . 14$$

Through Eq. 6 (definition of off-axis ratio), it can be deduced that:

$$Par . = \frac{Offset}{h / 2} = \frac{2 {h}_{1} ( {f}_{1}^{′} + {l}_{1} ) \sqrt{{L}^{2} + {W}^{2}}}{{af}_{1}^{′} W} \qquad Eq . 15$$

Performing calculation with the simulated parameters in the present disclosure, wherein h₁=13.85 mm, f′₁=125 mm, −l₁=10 mm, L/W=16:9, α=4.45 inches=113.03 mm, and applying these simulated parameters to Eq. 14 to obtain Par.=45.99%. This is very close to the result of LTs simulation of 45.8%, see FIG. 12.

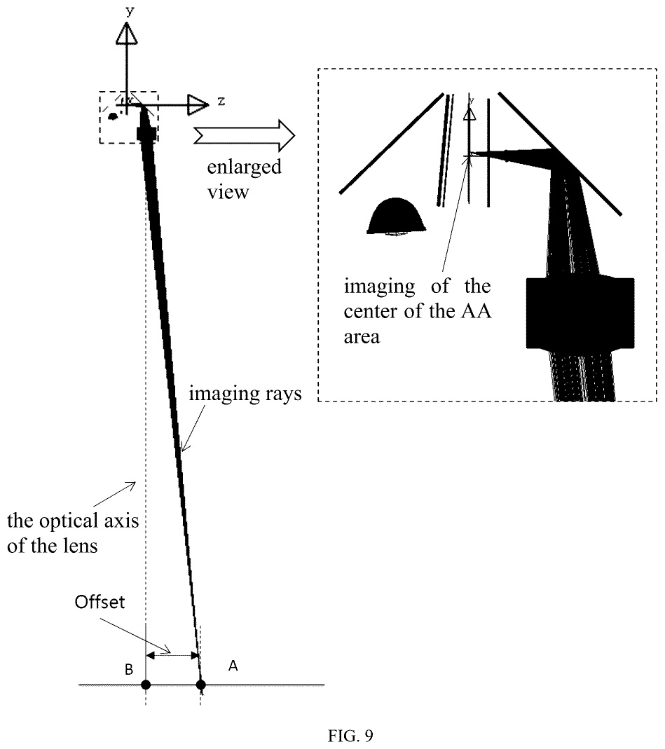

In the second case, the Fresnel lens is eccentric. FIG. 9 shows a structural diagram in which the optical axis of the projection lens is off-axis from the central axis of the display area. In the imaging optical path of a single LCD, the optical axis of the lens is raised in parallel by h₁, as shown in FIG. 9. The display area is the object of the imaging system, and the normal line passing through its center (that is, the central axis of the display area) can be defined as the optical axis of the imaging system. The direction of the optical axis is changed by 90° after passing through the imaging reflecting mirror and is parallel to the optical axis of the lens, but the distance between them is h₁. In this case, the projection lens belongs to off-axis imaging, which can achieve off-axis effects, as shown in FIG. 9. In FIG. 9, the center of the display area is imaged at point A on the screen, which is the center of the picture. And point B is the intersection point of the normal line of the screen passing through the center of the lens (here, it is the optical axis of the lens. When the screen is not perpendicular to the optical axis of the lens, this line is not the optical axis of the lens.) and the screen. Apparently, two points A and B are the off-axis amount Offset as mentioned above.

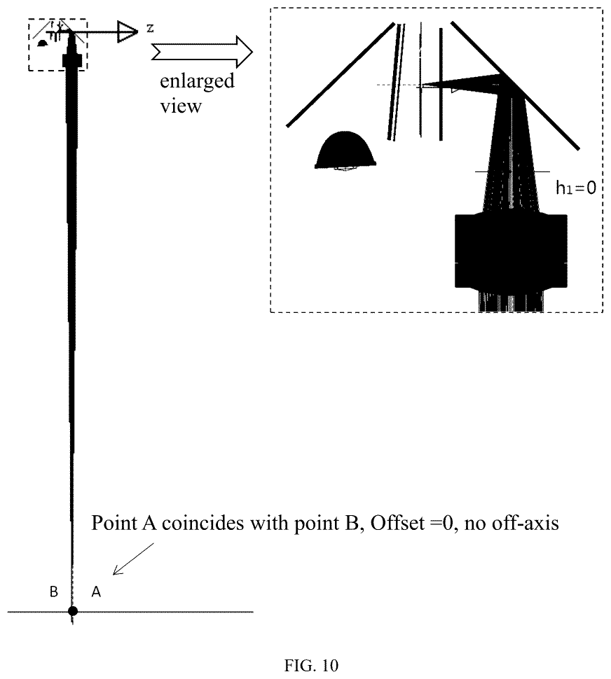

FIG. 10 is a schematic diagram of the imaging of the center of the display area where the lens is not off-axis, showing the effect of the comparison case H₁=0 (that is, coaxial imaging). It can be seen from FIG. 10 that when the optical axis of the lens and the system optical axis are coaxial, point A coincides with point B, and the off-axis amount Offset is 0.

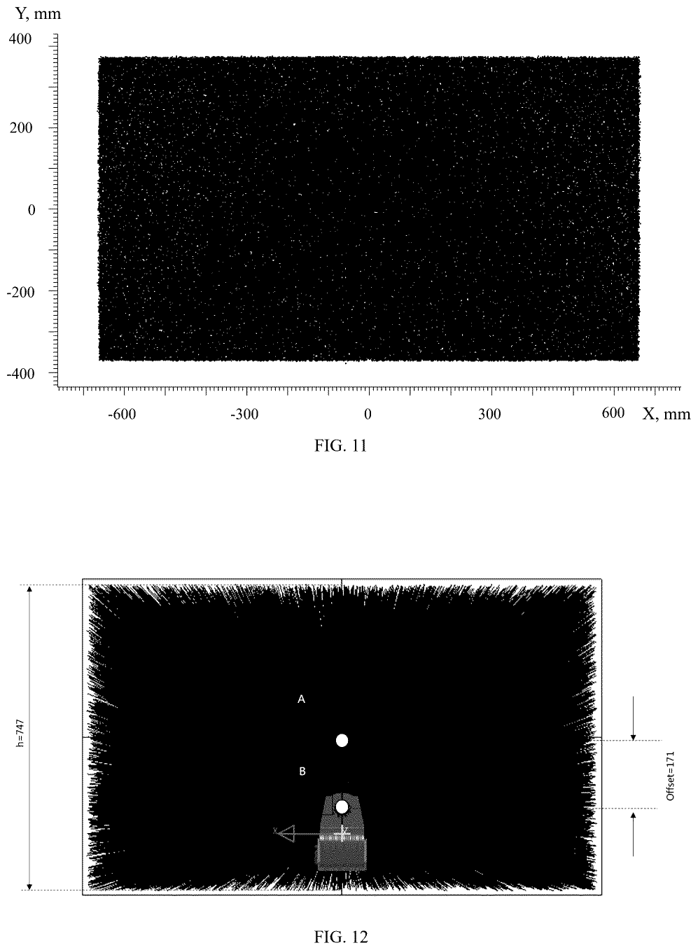

FIGS. 11 and 12 show the results of the simulations. FIG. 11 shows the size and shape of the projected picture on the screen. FIG. 12 shows the offset of the projected picture.

From the shape of the projected picture on the screen, it can be seen that the projected picture is rectangular, that is, this off-axis way does not produce trapezoidal deformation, and no optical or digital trapezoidal correction is required. Such features can be supported between 40-120 inches.

In the simulation, the offset of the measured projected picture is about: Offset=171 mm. The height of the projected picture is about: h=747 mm. Therefore, the off-axis ratio of the picture is: Par.=45.8%, which meets the use requirements of the user. In the context of the present disclosure, “the height of the projected picture” is relative to the length of the projected picture, so it can also be referred to as the width (W) of the projected picture.

Optionally, in some embodiments, the center of the projection lens is located at a first position, the system optical axis includes a second position, and a connecting line of the first position and the second position is perpendicular to the system optical axis, wherein the position of the projection lens is configured such that when the center of the projection lens moves from the second position to the first position, a connecting line from the center of the projected picture to the center of the projection lens coincides with the system optical axis.

In the context of the present disclosure, “the center of the projection lens” refers to the center of a thin lens equivalent to the projection lens. Although the projection lens may be composed of multiple groups of lens pieces, those having ordinary skills in the art can understand that each projection lens can be simplified into its equivalent thin lens.

Optionally, in some embodiments, the distance from the center of the projected picture to the system optical axis is linearly correlated to the distance from the projected picture to the projection lens.

Optionally, in some embodiments, the optical axis of the first lens coincides with the system optical axis; the off-axis ratio of the projected picture is

$$Par . 1 = \frac{2 {h}_{1} ( {f}_{1}^{′} + {l}_{1} ) \sqrt{{L}^{2} + {W}^{2}}}{{af}_{1}^{′} W} ,$$

wherein h₁ is the distance between the optical axis of the projection lens and the system optical axis, f′₁ is the image-side focal length of the first lens, −l₁ is the object distance of the display panel relative to the first lens, L is the length of the projected picture, W is the width of the projected picture, and α is the size of the diagonal line of the display area of the display panel. It should be noted that L and W are measured when the plane where the projected picture is located is perpendicular to the system optical axis. It should be noted that the off-axis ratio of the projected picture of the actual product may fluctuate by up to 10% compared with Par. 1. It can be considered that when the difference (absolute value) between the off-axis ratio of the projected picture of the actual product and the theoretical value of Par.1 is less than or equal to 10% of Par.1, it also falls within the range disclosed by the present application. The specific equation can be expressed as: the off-axis ratio of the projected picture of the actual product is

$$Par . 11 = {K}_{1} \times \frac{2 {h}_{1} ( {f}_{1}^{′} + {l}_{1} ) \sqrt{{L}^{2} + {W}^{2}}}{{af}_{1}^{′} W} ,$$

wherein the value range of K₁ is 0.9-1.1. Optionally, the value range of K₁ can be controlled within 0.95-1.05.

In the embodiments of the present disclosure, the length (L) of the projected picture and the width (W) of the projected picture are used as the parameters for calculating the off-axis ratio, but those having ordinary skills in the art can understand that the length to width ratio (L/W) of the projected picture may be equal to the length to width ratio of the display area of the display panel. Therefore, in all the equations used for calculating the off-axis ratio in the present disclosure, the length (L) of the projected picture can be replaced by the length of the display area of the display panel, and the width (W) of the projected picture can be replaced by the width of the display area of the display panel.

Optionally, in some embodiments, h₁ is in the range of −0.3 W_{AA} to 0.3 W_{AA}, wherein W_{AA} is the width of the display area of the display panel. When h₁ is in the range of −0.25 W_{AA} to 0.25 W_{AA}, a good off-axis projection of 0˜50% can be achieved. When h₁ is outside the range of −0.3 W_{AA} to 0.3 W_{AA}, the image quality may be reduced, especially when h₁ is greater than 0.3 W_{AA}, the display may be blurred, and the brightness and uniformity will be reduced.

When the lighting system is deflected at a certain angle, luminous flux can be increased, vignetting can be reduced, and the uniformity and brightness of the projected picture can be improved.

Optionally, in some embodiments, the optical axis of the light source and the system optical axis form a first angle that is non-zero; the light source is configured such that the rays propagating along the optical axis of the light source are emitted from a first side of the system optical axis to a second side of the system optical axis; wherein the plane where the optical axis of the light source and the system optical axis are located and the plane where the system optical axis and the optical axis of the projection lens are located are the same plane, the first side and the second side are respectively the two sides of the system optical axis, and the second side is the side where the system optical axis is located.

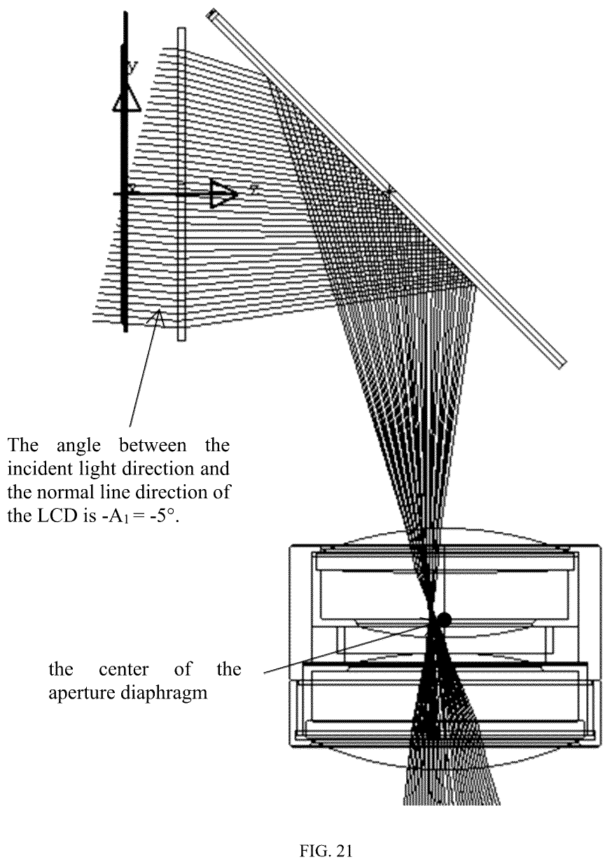

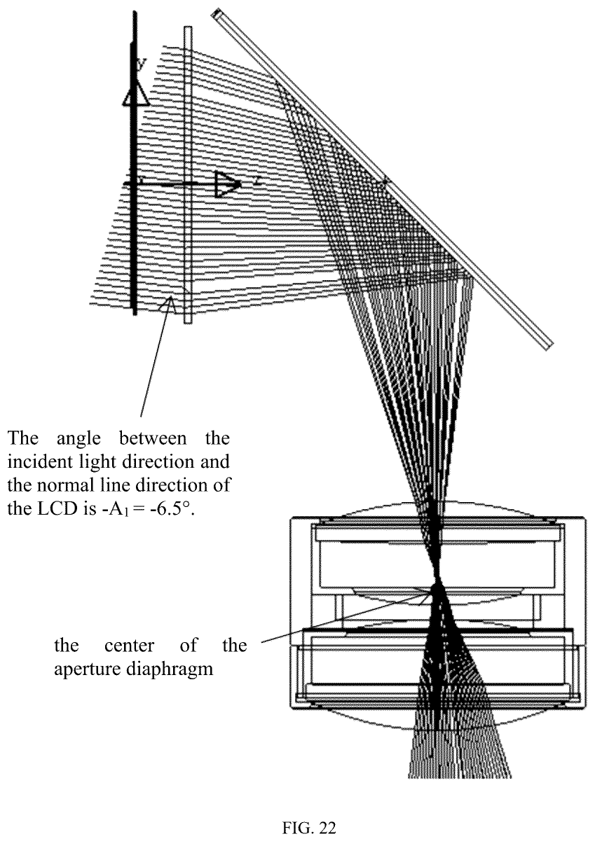

In some specific embodiments, as shown in FIG. 21 and FIG. 22, in some embodiments, the optical axis of the light source and the system optical axis form a first angle that is non-zero −A₁ (−A₁ is a negative number); the light source is configured such that the rays propagating along the optical axis of the light source are emitted from a first side of the system optical axis to a second side of the system optical axis; wherein the plane where the optical axis of the light source and the system optical axis are located and the plane where the system optical axis and the optical axis of the projection lens are located are the same plane, the first side and the second side are respectively the two sides of the system optical axis, and the second side is the side where the optical axis of the projection lens is located. In some other specific embodiments, relatively, the optical axis of the light source and the system optical axis may also form a first angle that is non-zero −A₁ (−A₁ is a positive number), the light source is configured such that the rays propagating along the optical axis of the light source is emitted from a second side of the system optical axis to a first side of the system optical axis; wherein the plane where the optical axis of the light source and the system optical axis are located and the plane where the system optical axis and the optical axis of the projection lens are located are the same plane, the first side and the second side are respectively the two sides of the system optical axis, and the first side is the side where the optical axis of the projection lens is located. When the lighting system is deflected at a certain angle, luminous flux can be increased, vignetting can be reduced, and the uniformity and brightness of the projected picture can be improved.

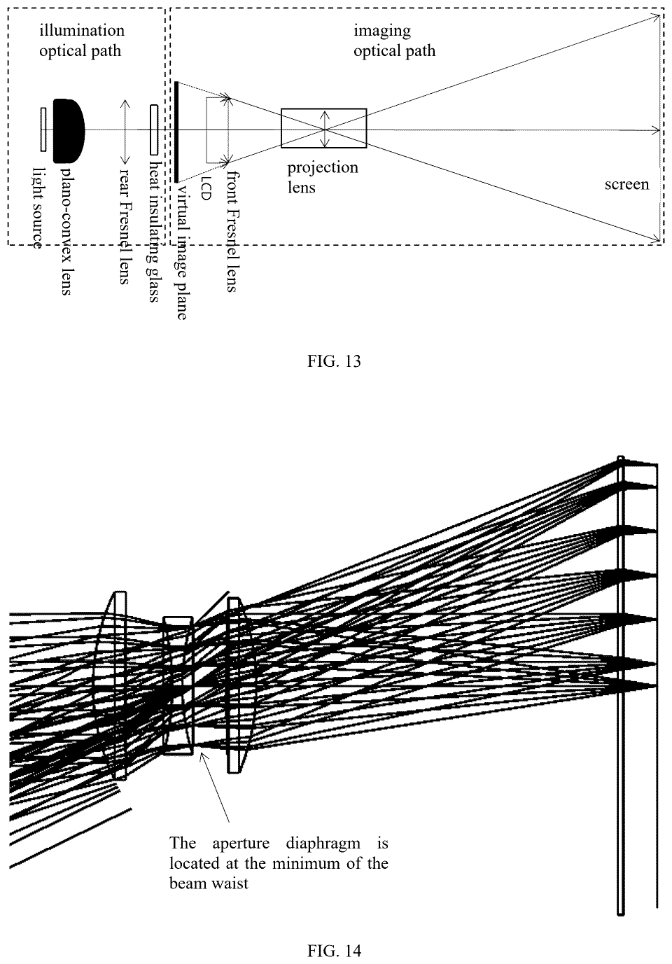

FIG. 13 shows the exploded schematic diagram of a single LCD projector along the optical path. The single LCD projector can be decomposed into two parts on the optical path, that is, the lighting system and the imaging system. The lighting system is mainly responsible for providing: an “area light source” with high light efficiency, high collimation (low divergence angle) and high uniformity. The imaging system is mainly responsible for displaying the picture and enlarging the picture (a magnification system with high resolution, high relative illuminance and low aberrations), as shown in FIG. 13.

Typically, a single LCD projector requires an object-side telecentric optical path, because the object-side telecentric optical path can maximize the utilization of rays. In the field of lens design, the object space and the image space are usually reversed to obtain an “image-side telecentric optical path”. The so-called object-side telecentric optical path means that the center of the entrance pupil is at infinity in the object side. The so-called entrance pupil refers to the image of the aperture diaphragm in the object side. The so-called aperture diaphragm refers to the diaphragm that plays a major role in the aperture angle of the on-axis object point in the optical imaging system, that is, when the light beam passes through the lens, the diaphragm at which the radius of the light beam is the smallest. The aperture angle refers to the angle between the ray and the optical axis, and generally the larger the aperture angle, the greater the aberration of the ray. The position and size of the aperture diaphragm can be clearly known in the source file of the simulation software. FIG. 14 is a three-dimensional layout diagram of the aperture diaphragm.

In an optical system, the ray passing through the center of the aperture diaphragm is referred to as the “chief ray”, and the chief ray also passes through the center of the pupil. If the chief ray passes through the center of the entrance pupil, and the entrance pupil is at infinity, it is the object-side telecentric optical path. If the chief ray passes through the center of the exit pupil, and the exit pupil is at infinity, it is the image-side telecentric optical path.

The image of the center of the aperture diaphragm at the object side is the center of the entrance pupil. The object-side telecentric optical path requires the center of the pupil to be at infinity in the object side, which means that the rays parallel to the optical axis pass through the center of the aperture diaphragm, that is, the chief ray is required to be parallel to the optical axis (“the normal line passing through the center of the display area”). This means that the rays emitted by the lighting system should be parallel to the optical axis of the imaging system (“normal line passing through the center of the display area”).

An object point always participates in imaging with a cone-shaped light beam with a certain divergence angle. When the divergence angle increases from 0 to a certain value, the ray at a large angle will always be blocked by the aperture diaphragm. In particular, for the imaging of an off-axis point, the divergence angle of the object point that is farther off-axis to participate in imaging is more limited by the aperture diaphragm. Therefore, in the image plane, areas closer to the optical axis are brighter, and edges farther off-axis are darker. This is the phenomenon of vignetting. Therefore, the divergence angle of the lighting system should be as small as possible, and the higher the light intensity, the better (meaning that the rays are concentrated in a smaller solid angle). At this point, the rays from the lighting system can be considered to have a “main direction”. The light source is most efficiently utilized when the main direction and the direction of the chief ray overlap. Therefore, the lighting system of a single LCD projector typically illuminates the LCD panel perpendicularly.

In the embodiments of the present disclosure, in order to achieve off-axis, off-axis imaging is adopted. The center of the aperture diaphragm is not on the system optical axis, and the original rays parallel to the system optical axis do not pass through the center of the aperture diaphragm, and are not the “chief ray” in the optical sense, as shown in FIG. 16.

The object-side telecentric optical path only defines that the center of the entrance pupil is at infinity in the object side, regardless of whether it is off-axis or not. Chief rays are not defined as the rays parallel to the optical axis in the object side, either, but as the rays passing through the aperture diaphragm. If the illumination optical path adopts oblique illumination, even if the chief rays are not parallel to the optical axis, it can be referred to as object-side telecentric optical path.

In an actual optical path, even if (the virtual image of) the pupil is at infinity in the image side, it can be considered as an approximate object-side telecentric optical path. This is because: assuming that the chief rays form an infinitely small angle that is less than zero, the pupil is in the object space; assuming that the chief rays form an infinitely small angle that is greater than zero, the virtual image of the pupil is in the image space.

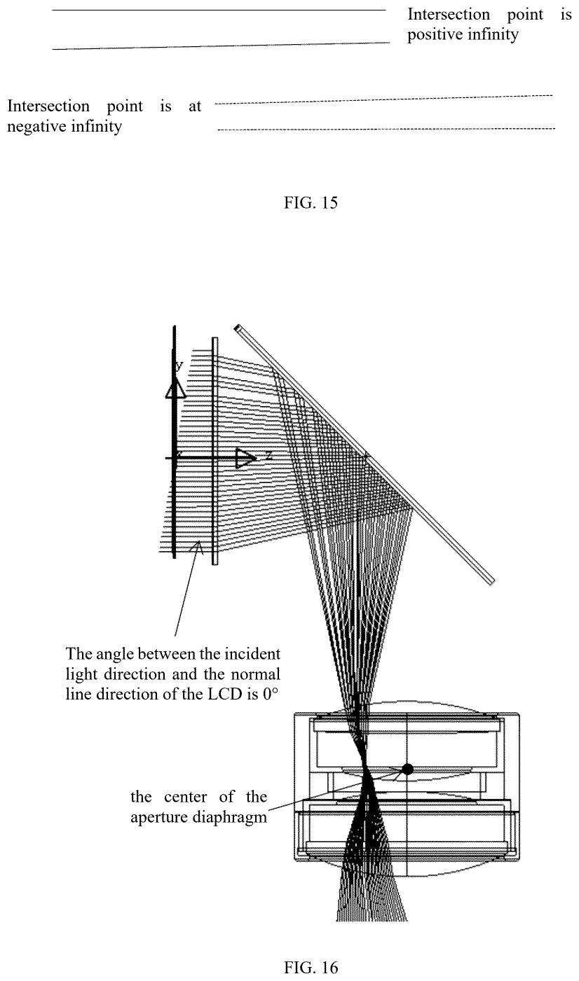

Similarly, in the simulation, the position of the exit pupil is theoretically at infinity in the image side, and the value is positive infinity. But the intersection point of parallel lines can be considered to be at either positive infinity or negative infinity. At positive infinity, the rays are “a little bit convergent”, and at negative infinity, the rays are “a little bit divergent”. Therefore, no matter the value of EXPP is greater than zero or less than 0, as long as the absolute value is large enough, it can be considered as the image-side telecentric optical path. FIG. 15 is the schematic diagram of the intersection point of the chief rays in the image-side telecentric optical path. FIG. 16 is the schematic diagram of the original non-chief rays.

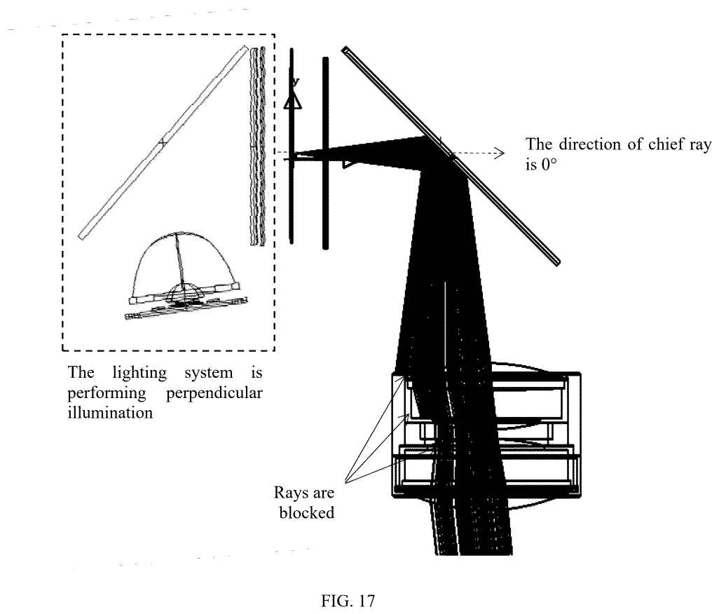

FIG. 17 is the schematic diagram of the imaging of the rays from the center of the display area when the lighting system is performing perpendicular illumination. In this case, for imaging of the object point in the center of the display area, some rays are blocked by the aperture diaphragm, and even some of the light cannot enter the projection lens, as shown in FIG. 17.

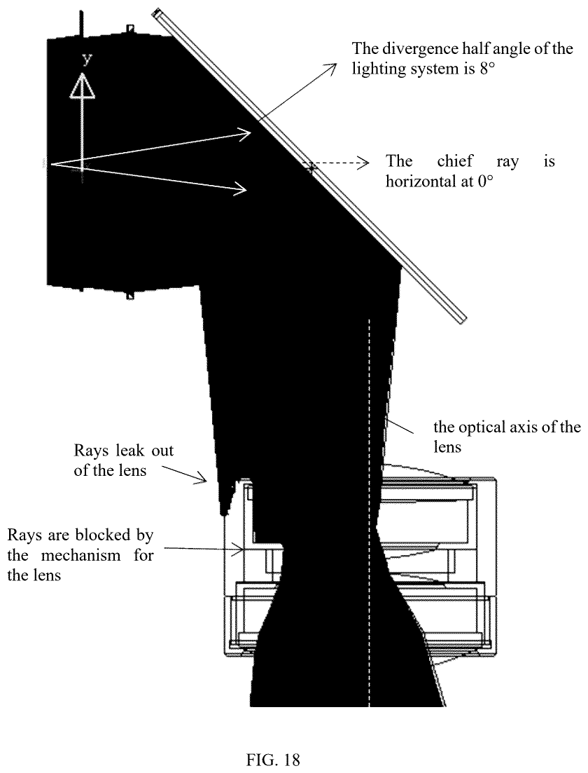

FIG. 18 is the schematic diagram of ray trajectories when the lighting system is performing perpendicular illumination. If the lighting system is simplified as an area light source for simulation, the size of the area light source may be set to be equal to the display area (98.5 mm*55.4 mm) or slightly larger, and the divergence half angle of the area light source is set as 8°. According to the actual lighting system simulation experience, the divergence half angle is about 8°±2°. If the value exceeds 10°, it indicates that the collimation of the lighting system is poor and the utilization rate is low, so it is necessary to adjust the Fresnel lens, the optical cup, the plano-convex lens and the like, as shown in FIG. 18.

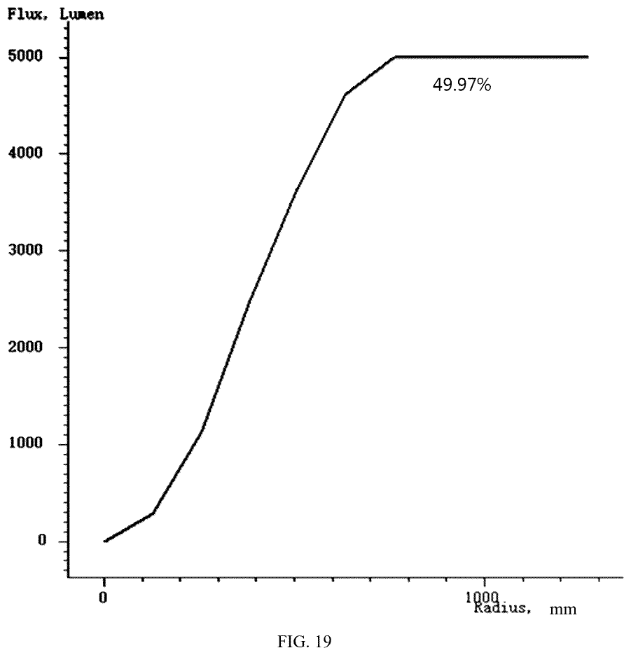

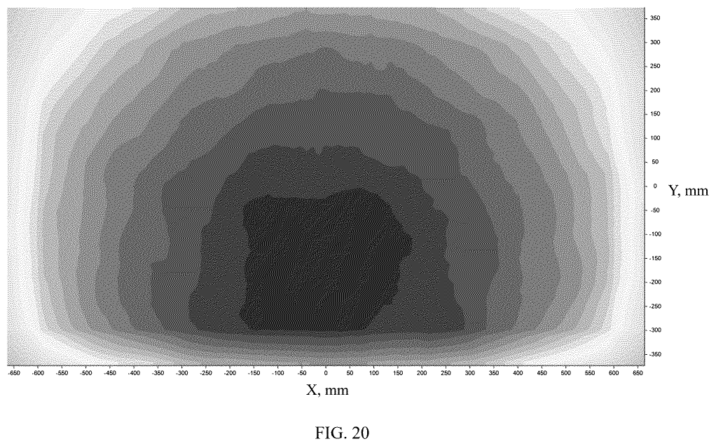

FIG. 19 shows the relative light utilization rate when the lighting system is performing perpendicular illumination. When the input luminous flux of the light source is 10000 Lm, after simulation, the acceptable relative luminous flux on the screen is 49.97% when the lighting system is performing perpendicular illumination, as shown in FIG. 19.

At the same time, there may also be serious vignetting phenomenon in the light spot on the screen—the distribution of illumination is uneven, and the extreme value of illumination is seriously deviated from the center of the picture. FIG. 20 shows the light spot when the lighting system is performing perpendicular illumination.

In an embodiment of the present disclosure, according to the chief rays of an off-axis system, the lighting system should be rotated by a certain angle, as shown in FIG. 21. FIG. 21 is the schematic diagram of parallel rays illuminating obliquely at an angle of −5°.

It can be seen that when the parallel rays are clockwise rotated by 5°, the ray convergence center is close to the center of the aperture diaphragm, indicating that the parallel rays in this direction are close to the chief rays of the system.

Optionally, when the rotation angle is 6.5°, FIG. 22 shows the schematic diagram of oblique illumination of parallel rays. At this time, the intersection point of the parallel rays just passes through the center of the aperture diaphragm, forming the object-side telecentric optical path, and the light utilization rate can be maximized.

Considering that there may be structural and imaging problems if the rotation angle of the lighting system is too large, the rotation angle of the lighting system is set as 5°. In terms of structure, if the rotation angle of the lighting system is too large, it will cause uneven gaps between the heat insulating glass and the LCD, which will lead to problems such as increased volume of the projector and enlarged elements. In terms of imaging, oblique illumination is for the improvement of brightness and uniformity. In terms of imaging quality, oblique illumination actually means that rays with a larger aperture angle are used for imaging, which is contrary to the theory of paraxial light forming an ideal image, and thus results in greater aberrations.

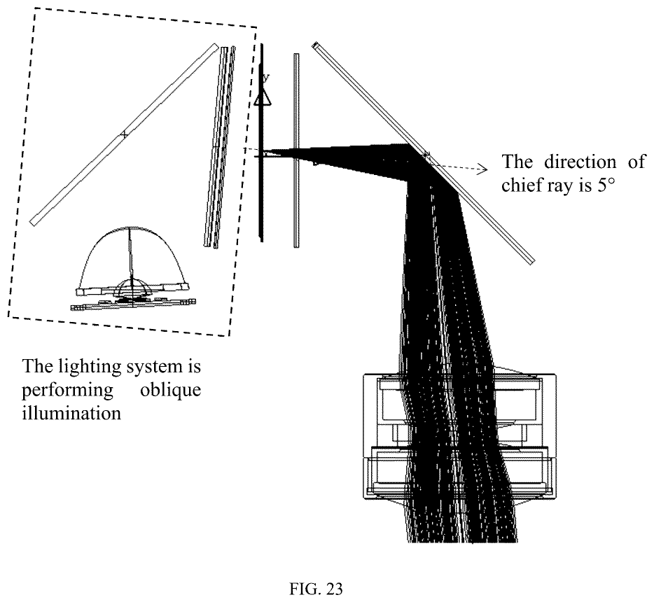

FIG. 23 is the schematic diagram of oblique illumination of the lighting system. As shown in FIG. 23, when the lighting system illuminates obliquely at 5°, the angle between the main direction of the rays and the normal line of the center of the display area is 5°, and the light beam with an aperture angle of 8° forms an image—basically all the rays are not blocked by the frame and the aperture diaphragm, completely passing through the lens to reach the screen. The aperture angle refers to the angle between the ray and the optical axis. Within a certain object height range, typically the smaller the object height, the closer to the paraxial imaging, and the better the imaging quality.

It should be noted that in the simulation, the maximum aperture angle at this time should be: 5°+8°=13°. And when performing perpendicular illumination, the maximum aperture angle of imaging is: 8°. Generally, the aberration of imaging with a large aperture angle may be greater than that of imaging with a small aperture angle. Therefore, the angle of oblique illumination is not the greater the better.

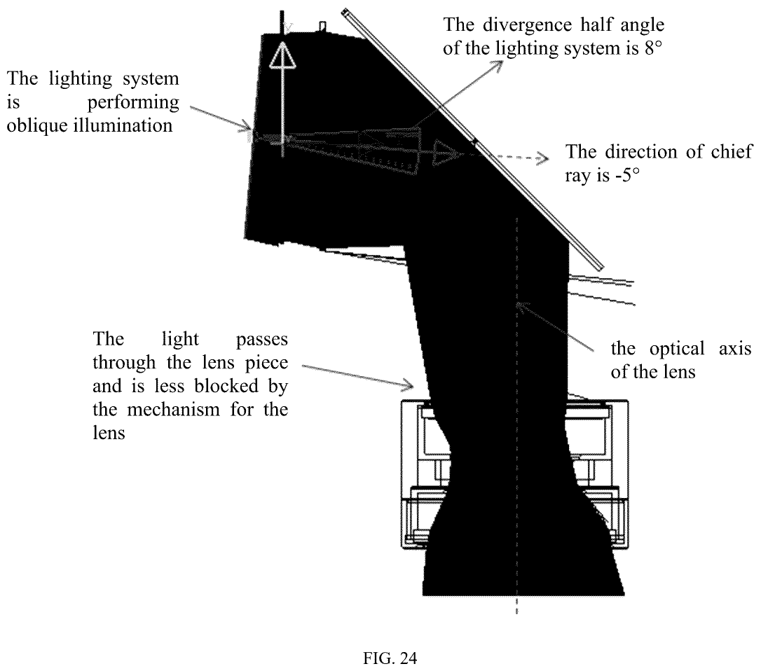

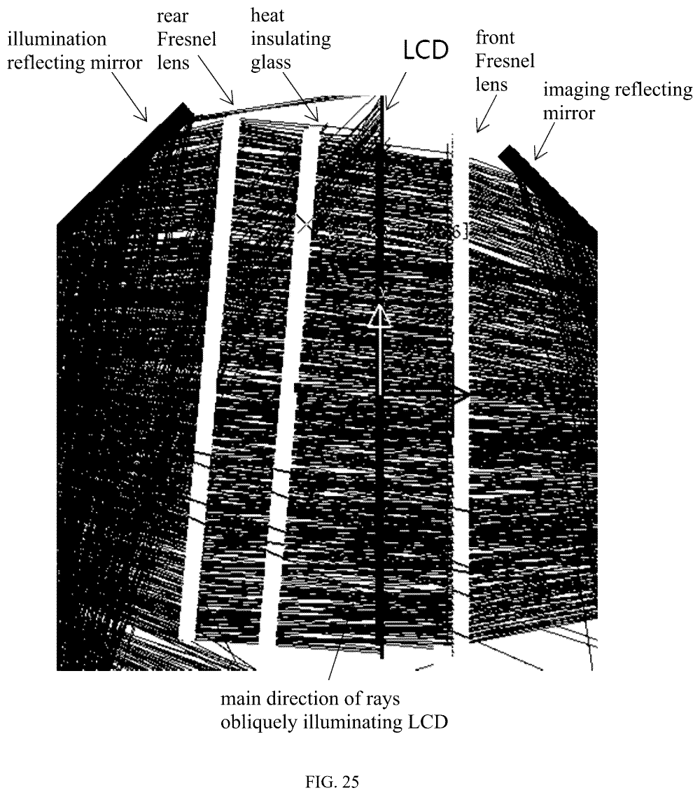

FIG. 24 is the schematic diagram of ray trajectories of oblique illumination of the lighting system. FIG. 25 is the detailed schematic diagram of an LCD being illuminated obliquely by the rays from an actual light source. As shown in FIG. 24, if the lighting system is simplified to an area light source for simulation, the size of the area light source may be set to be the same size as the display area (98.5 mm*55.4 mm) or slightly larger, and the divergence half angle of the area light source is set as 8°.

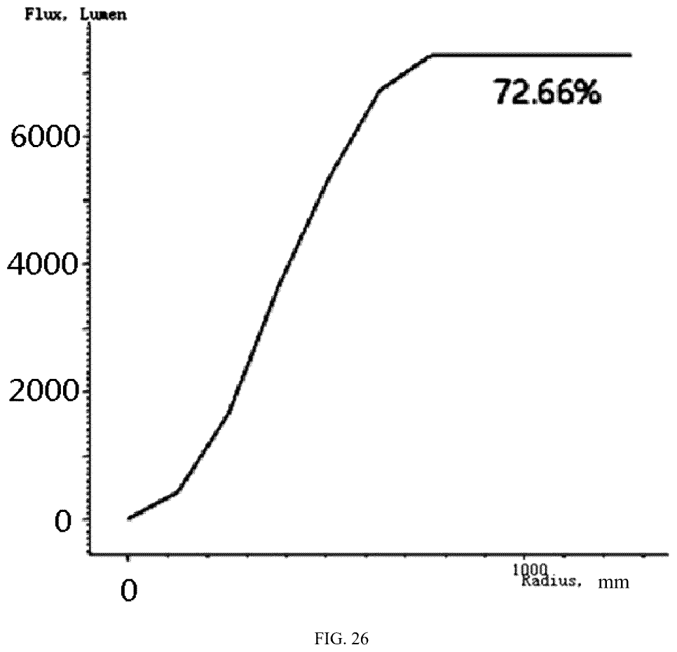

FIG. 26 shows the relative light utilization rate of the lighting system for oblique illumination. It can be seen that when the lighting system illuminates obliquely, most of the rays pass through the lens, and there is no apparent light leakage. In this regard, the luminous flux received on the screen is simulated, and the efficiency reaches 72.66%, the absolute efficiency is 22.69% higher than normal incidence.

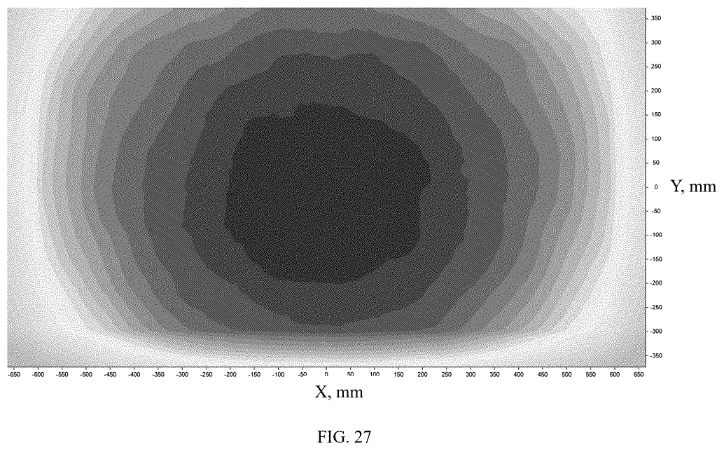

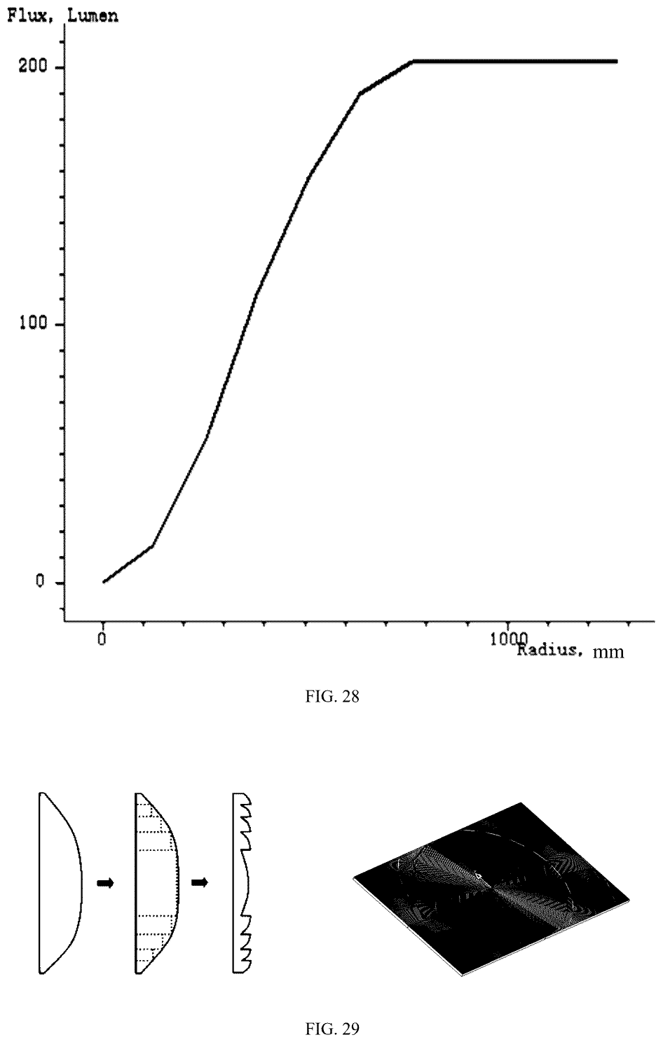

At the same time, since the chief rays substantially pass through the center of the aperture diaphragm, the vignetting phenomenon is also greatly reduced, and the peak center of the brightness on the screen basically coincides with the center of the projected picture, ensuring the uniformity of brightness. FIG. 27 shows the light spot on the screen when the lighting system is performing oblique illumination. FIG. 28 shows the luminous flux received by the screen when the lighting system is performing oblique illumination (maximum value is 201.8 Lm).

The relationship between lens offset and light source rotation angle should be discussed separately in two cases. In the first case, the front Fresnel lens has no eccentricity; in the second case, the front Fresnel lens has an eccentricity.

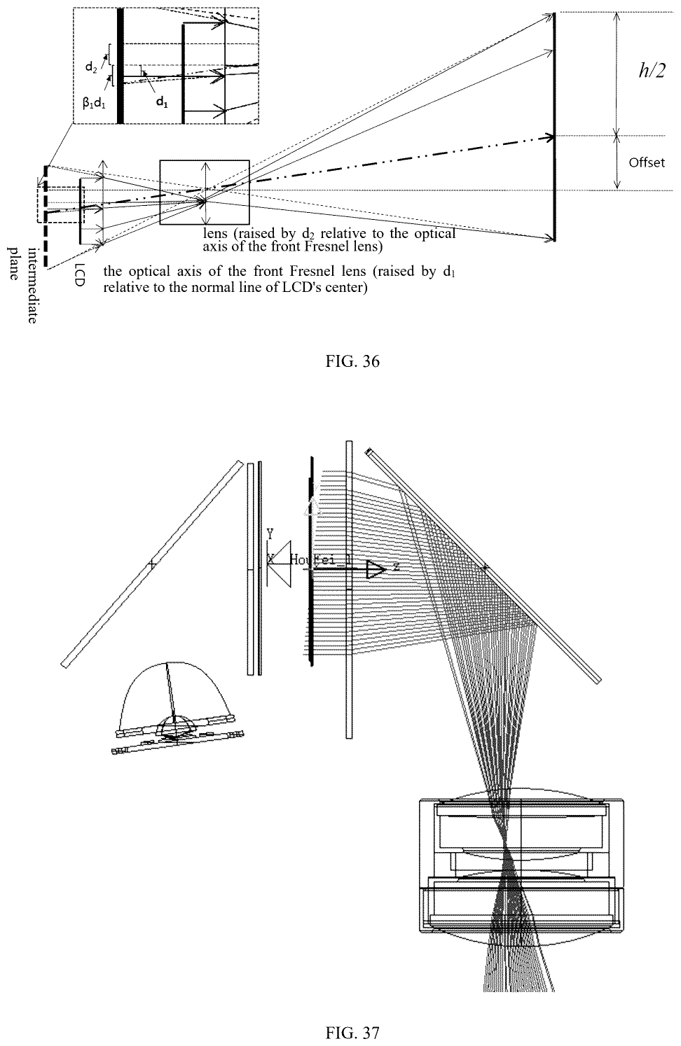

In an ideal situation (an actual system may be designed in the direction of an ideal system), the imaging optical path may form the object-side telecentric optical path. At this time, the focal plane of the front Fresnel lens is on the plane of the lens aperture diaphragm, as shown in FIG. 1, FIG. 7, FIG. 9, FIG. 13, FIG. 36, and so on. The purpose of rotating the lighting system at a certain angle (oblique illumination) is to change the position of the intersection point through oblique illumination (note: here is “intersection point” rather than “focus point”, because “focus point” has a specific physical meaning, that is: the point where the rays parallel to the optical axis converge), so that it is close to the center of the aperture diaphragm. At this time, the center of the aperture diaphragm has a translation amount h₁. Therefore, the problem can be simplified as: when the front Fresnel lens has an eccentricity d₁ and the projection lens is offset by h₁ relative to the LCD, find the angle A₁ that the lighting system needs to be rotated.

In the process of solving this problem, the design parameters of the lens have an impact on the result. The position of the aperture diaphragm is actually related to the lens design. In addition, the position of the converging point of the rays emitting from the front Fresnel lens in the lens is also related to the parameters of the one or two lens pieces in front. However, using the expression of −A₁ as presented in the present disclosure, the angle at which the lighting system needs to be rotated can be obtained directly according to the displacements of the front Fresnel lens and the projection lens relative to the system optical axis. Therefore, the above-mentioned approximate analysis provided by the present disclosure not only simplifies the calculation, but also skillfully transforms the solution elements of the above-mentioned problem into the above-mentioned “displacement” that is easier to measure and design.

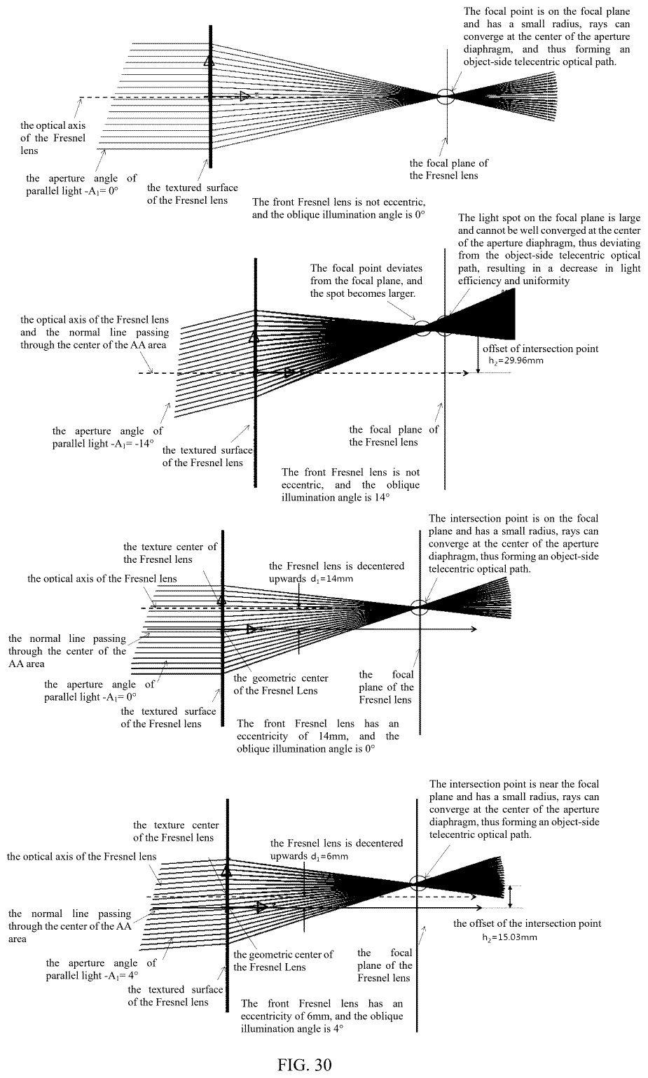

FIG. 29 shows the structural changes of the plano-convex lens and the Fresnel lens. The Fresnel lens can be regarded as a “collapsed” plano-convex lens (as shown in FIG. 29), and its optical performance is similar to that of the plano-convex lens (the thickness and spherical aberration of the plano-convex lens are optimized). These two types of lenses have the characteristics that when the rays are incident parallel to the optical axis (incident from a curved surface), the rays can converge well on the focus point. FIG. 30 shows the intersection points on the Fresnel lens under different oblique illumination angles. When the rays illuminate the Fresnel lens obliquely at the aperture angle A₁, since the curved surfaces above and below the optical axis are no longer rotationally symmetric and the converging rays are no longer rotationally symmetric, the rays cannot be well converged into a point (because the rays at different positions have different optical paths). Therefore, A₁ should not be particularly large (e.g.) A₁<10°, otherwise it will destroy the object-side telecentric optical path. As shown in FIG. 30, when the Fresnel lens is illuminated obliquely, the offset h₂ of the intersection point is related to the focal length f′₁, the eccentricity d₁ and the oblique illumination angle A1 of the Fresnel lens, and thus can be simulated for curve fitting.

TABLE 4
Referring to FIGS. 30-32, intersection point offset h₂ under different
Fresnel lens eccentricity d₁ and oblique illumination angle A₁

| | d₁ | | | | | | | |
|---|---|---|---|---|---|---|---|---|
| | 0 mm | 2 mm | 4 mm | 6 mm | 8 mm | 10 mm | 12 mm | 14 mm |
| −A₁ | h₂ | | | | | | | |
| 0° | 0 | 1.96 | 4.02 | 5.97 | 8.06 | 10.05 | 12.05 | 14.07 |
| 2° | 4.36 | 6.46 | 8.39 | 10.56 | 12.5 | 14.5 | 16.48 | 18.51 |
| 4° | 3.78 | 11.03 | 12.81 | 15.03 | 16.96 | 19.07 | 21.17 | 23.14 |
| 6° | 12.75 | 15.46 | 17.85 | 19.56 | 21.57 | 23.59 | 25.74 | 27.93 |
| 8° | 17.53 | 19.65 | 22.22 | 23.95 | 26 | 28.22 | 30.28 | 32.41 |
| 10° | 21.21 | 24.29 | 26.89 | 28.42 | 30.47 | 32.65 | 34.82 | 37.27 |
| 12° | 25.58 | 28.2 | 30.97 | 33.05 | 35.18 | 37.31 | 39.74 | 41.59 |
| 14° | 29.96 | 33.15 | 35.78 | 37.4 | 39.94 | 42.08 | 44.45 | 46.57 |

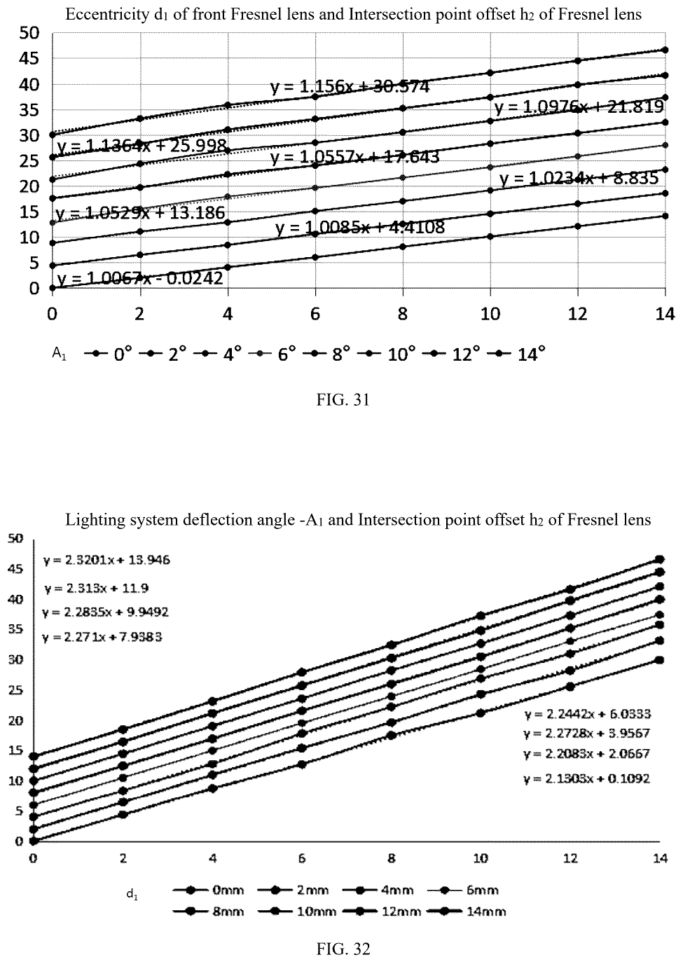

FIG. 31 shows the relationship between the eccentricity of the front Fresnel lens and the intersection point offset of the Fresnel lens under different oblique illumination angles. The curves in FIG. 31 can be plotted according to the simulated data in Supplementary Table 2. It can be seen from FIG. 31 that under the same oblique illumination angle, the eccentricity of the Fresnel lens and the intersection point offset of the Fresnel lens are approximately in a linear relationship.

FIG. 31 shows the offset of the intersection point of the Fresnel lens under the condition that the oblique illumination angle is fixed and the Fresnel lens has an eccentricity. The process shown in FIG. 31 is simulating the principle of reducing vignetting, or the process of turning the main rays into the chief rays, appearing an approximately linear relationship. FIG. 32 shows the offset of the intersection point of the Fresnel lens under the condition that the eccentricity of the Fresnel lens is fixed and the oblique illumination angles are different. The process shown in FIG. 32 is simulating the principle of reducing vignetting, or the process of turning the main rays into the chief rays, appearing an approximately linear relationship. Using the approximate linear relationships shown in FIG. 31 and FIG. 32, the offset of the intersection point of the Fresnel lens can be calculated very simply according to the eccentricity of the front Fresnel lens, or the offset of the intersection point of the Fresnel lens can be calculated according to the oblique illumination angle, or the eccentricity of the front Fresnel lens and the oblique illumination angle can be calculated according to the offset of the intersection point of the Fresnel lens, so that the illumination optical path and imaging optical path can be structurally linked and matched in the product to achieve the best effect.

Optionally, in some embodiments, the light beam emitted by the light source converges at a first intersection point after passing through the first lens, and the shortest distance between the first intersection point and the system optical axis has a linear relationship with the first angle, and the shortest distance between the first intersection point and the system optical axis increases as the first angle increases. It should be noted that the linear relationship includes an approximate linear relationship.

Optionally, in some embodiments, the first angle −A₁=arctan ((d₁+d₂)/f′₁), wherein d₁ is the distance between the optical axis of the first lens and the system optical axis, d₂ is a difference between the distance of the optical axis of the projection lens and the system optical axis and the distance of the optical axis of the first lens and the system optical axis, and f′₁ is the image-side focal length of the first lens, −l₁ is the object distance of the display panel relative to the first lens. It should be noted that the absolute value of the first angle of an actual product may be equal to or smaller than the absolute value of −A₁, and the difference from the absolute value of −A₁ is within 3°. It can be considered that when the difference between the absolute value of the first angle of an actual product and the absolute value of −A₁ is less than or equal to 3°, the actual product is also within the scope of the disclosure of the present application.

Optionally, in some embodiments, the angle between the light beam propagation direction along the optical axis of the light source and the system optical axis is in a range from 2° to 7°.

Optionally, in some embodiments, the light emitted by the light source is a collimated light beam. Specifically, a collimated light beam can be defined as a light beam whose divergence half angle is less than or equal to 15°.

Optionally, in some embodiments, the light source is rotatable, and the optical axis of the light source passes through the center of the display area of the display panel, and the light source is configured such that an optical axis of the light source forms a first angle that is non-zero with the system optical axis. In the context of the present disclosure, “the center of the display area” may be the very center of the display area, or the central area of the display area. The “central area” can be a circular area with the very center of the display area as the center of circle, or a rectangular area with the very center of the display area as the center; the area of the circular area or the rectangular area may be 0.01%˜20% of the area of the display area, such as 0.01%, 0.1%, 1%, 5%, 10%, 12.5% or 20%.

FIG. 32 shows the relationship between the lighting system deflection angle −A₁ and the Fresnel lens intersection point offset h₂ under different eccentricities of the front Fresnel lens. The curves in FIG. 32 can be plotted according to the simulated data in Supplementary Table 2. It can be seen from FIG. 32 that under the same eccentricity of the Fresnel lens, the deflection angle of the lighting system and the offset of the intersection point of the Fresnel lens are in an approximately linear relationship.

It should be noted that the above simulation is for the case that the focal length of the Fresnel lens is 125 mm, and the fitting curve may have different coefficients for Fresnel lenses with other focal lengths.

In some embodiments of the present disclosure, by adjusting the position of the lighting system, the peak brightness is set at the center of the projected picture.

FIG. 33 shows the position matching of the lighting system and the imaging system. The lighting system and the imaging system need to be matched in position. As shown in FIG. 33, the optical axis of the illumination system must pass through the center of the display area of the LCD to provide the imaging system with a symmetrical illuminance distribution about the center. This is a necessary condition to ensure uniformity on the screen and prevent vignetting of the projected picture.

The offset of the lens is adjustable up and down, and correspondingly, the lighting system can also be rotated. In order to ensure that the center of the lighting system can illuminate the center of the display area, structurally, the lighting system can be rotated according to the axis passing through the center of the display area.

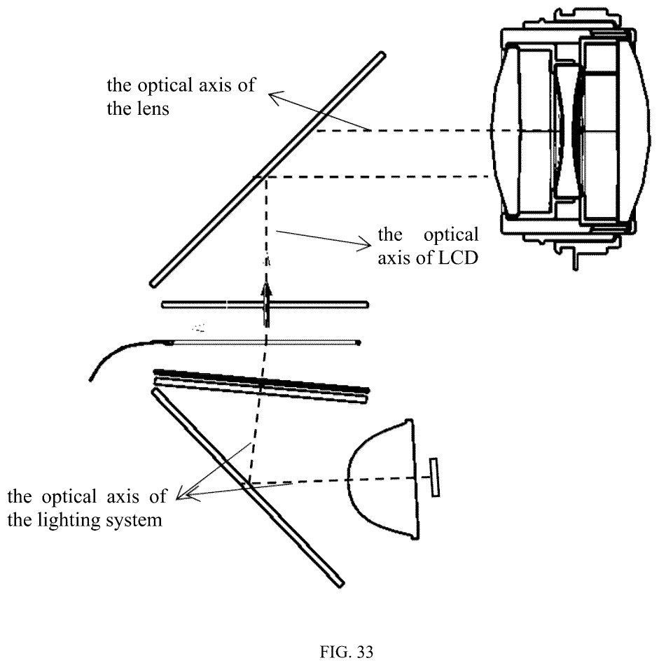

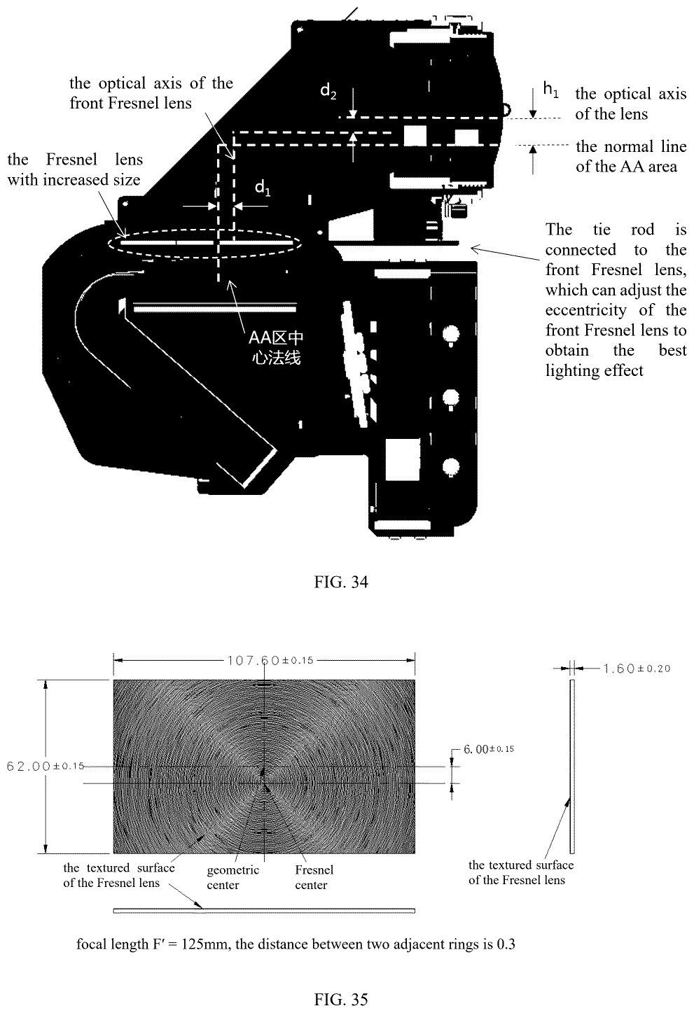

The actually used eccentricity of the front Fresnel lens can be adjusted structurally. FIG. 34 shows that the eccentricity used by the front Fresnel lens is adjustable. The front Fresnel lens shown in FIG. 34 may have a larger size and be connected to the outside through a tie rod (connecting rod, screw rod). It can be seen from FIG. 32 that under different eccentricities, the offset of the intersection point of the front Fresnel lens is variable, and the object-side telecentric optical path is formed through the cooperation of lens elevation (if the lens elevation is also made structurally adjustable) to satisfy the requirements of different off-axis ratio projections.

At the same time, the eccentricity of the front Fresnel lens can improve the position of the peak illumination of the projected picture, thereby adjusting the uniformity of the projected picture and improving the perception. The vignetting is the smallest when the chief rays pass through the center of the aperture diaphragm, and the peak illuminance of the projected picture is at the center of the picture. When the oblique illumination angle is insufficient, for example, 6.2° is required, and the actual oblique illumination angle is only 5°, the intersection point of the main direction rays is not at the center of the aperture diaphragm, and there may be certain vignetting, that is, the peak illuminance of the projected picture deviates from the center of the picture. At this time, by adjusting the eccentricity of the front Fresnel lens, the intersection point of the main direction rays can be corrected to make it closer to the center of the aperture diaphragm, thereby reducing vignetting.

In the previously analyzed optical path, the front Fresnel lens is “centered”. The so-called “centered” means that the effective area of the front Fresnel lens is rotationally symmetrical about its optical axis, or that the texture center of the front Fresnel lens is at the center of the effective imaging area. An “eccentric” Fresnel lens is one in which the texture center is offset from the center of the effective imaging area. When in use, the optical axis of the centered Fresnel lens is typically coaxial with the system optical axis; the optical axis of the eccentric Fresnel lens is off-axis from the system optical axis, and the off-axis amount is generally equal to the eccentricity of the Fresnel lens.

The eccentricity of the Fresnel lens is generally realized by injection molding, or by eccentrically cutting the centered Fresnel lens. Generally, the eccentricity of zero to tens of millimeters can be realized, especially 4-6 mm.

The textured surface of the Fresnel lens faces the LCD, and the surfaces are parallel to each other. The air gap between the two surfaces is the object distance for the first imaging (−l₁=10 mm in this embodiment). The normal line passing through the center of the display area passes through the geometric center of the front Fresnel lens.

In some embodiments, the distance between the optical axis of the projection lens and the system optical axis is variable (for example, the projection lens is liftable). The projection lens and the first lens are configured such that the light emitted by the light source can sequentially pass through the display panel, the first lens, the projection lens and then exit. It should be noted that the projection lens is liftable, which means that in the projector product described in this embodiment, the relative position of the projection lens can be changed to realize the change of the off-axis ratio of the projected picture.

Optionally, in some embodiments, the distance between the optical axis of the projection lens and the system optical axis is variable (for example, the projection lens is liftable), and the first lens is adjustable in eccentricity. The projection lens and the first lens are configured such that the light emitted by the light source can sequentially pass through the display panel, the first lens, the projection lens and then exit. Therefore, in the projector product described in this embodiment, the relative position of the projection lens can be changed, and at the same time, the relative position of the first lens can also be changed, so as to achieve better imaging quality while changing the off-axis ratio of the projected picture.

In some embodiments, the distance between the optical axis of the projection lens and the system optical axis is variable (for example, the projection lens is liftable), and the angle formed by the optical axis of the light source and the system optical axis is variable. The projection lens and the first lens are configured such that the light emitted by the light source can sequentially pass through the display panel, the first lens, the projection lens and then exit. Therefore, in the projector product described in this embodiment, the relative position of the projection lens can be changed, and at the same time, the angle formed by the optical axis of the light source and the system optical axis can also be changed, so as to realize the change of the off-axis ratio of the projected picture and have better imaging brightness at the same time. Preferably, the amount of change in the angle formed by the optical axis of the light source and the system optical axis is in a linear relationship with the amount of change in the distance between the optical axis of the projection lens and the system optical axis. It should be noted that the linear relationship includes an approximately linear relationship.

In some embodiments, the distance between the optical axis of the projection lens and the system optical axis is variable (for example, the projection lens is liftable), the angle formed by the optical axis of the light source and the system optical axis is variable, and the first lens is adjustable in eccentricity. The projection lens and the first lens are configured such that the light emitted by the light source can sequentially pass through the display panel, the first lens, the projection lens and then exit. This embodiment can realize the change of the off-axis ratio of the projected picture and have a better display effect at the same time. Preferably, the amount of change in the angle formed by the optical axis of the light source and the system optical axis is in a linear relationship with the amount of change in eccentricity of the first lens. It should be noted that the linear relationship includes an approximate linear relationship. Preferably, the amount of change of the angle formed by the optical axis of the light source and the system optical axis is in a linear relationship with d₂; it should be noted that the linear relationship includes an approximate linear relationship; wherein, d₂ is the difference between the distance of the optical axis of the projection lens and the system optical axis and the distance of the optical axis of the first lens and the system optical axis.

In some embodiments, the change of the distance between the optical axis of the projection lens and the system optical axis may be linked with the adjustment of the angle formed by the optical axis of the light source and the system optical axis of the system and/or the eccentricity of the first lens, that is, through electrical or mechanical control, the user can realize raising the projection lens and the adjustment of the angle between the optical axis of the light source and the system optical axis and/or the eccentricity of the first lens at the same time through one operation (for example: one-key operation).

Optionally, in some embodiments, the first lens is a Fresnel lens, the first lens includes a textured surface with a texture center, the textured surface faces the display panel, and the textured surface is parallel to on the extended plane of the display panel; the system optical axis intersects the first lens at the geometric center of the textured surface, and the optical axis of the first lens passes through the texture center; the texture center does not coincide with the geometric center.

Optionally, in some embodiments, the distance between the texture center and the geometric center is in the range of 2-8 mm.

FIG. 35 is the 2D schematic diagram of an eccentric Fresnel lens. The principle of off-axis implementation described above is based on the fact that the front Fresnel lens is centered. In fact, an eccentric front Fresnel lens can also be used. FIG. 36 is the schematic diagram of eccentric imaging of the front Fresnel lens.

The equation for calculating the off-axis ratio when the front Fresnel lens is not eccentric is given above, the equation for calculation when the front Fresnel lens is eccentric is given here. The front Fresnel lens is designed to be eccentric, which can improve the imaging quality of the projector. From the calculation equation derived below, it can be seen that by using the relationship between the offset of the intersection point of the front Fresnel lens, the eccentricity of the front Fresnel lens, and the oblique illumination angle, the eccentricity can be calculated in a simplified manner, thereby simplifying the design process.

Unlike the centering of the front Fresnel lens, the object height of the LCD changes when the front Fresnel lens is eccentric. Assuming that the eccentricity of the front Fresnel lens is d₁, in the height direction of the projected picture, the object height of the LCD becomes:

$$- {y}_{1} = 0.5 * {W}_{AA} + {d}_{1} \qquad Eq . 16$$

wherein W_{AA} is the height of the display area,

$${W}_{AA} = \frac{aW}{\sqrt{{L}^{2} + {W}^{2}}} \qquad Eq . 17$$

the image height to the intermediate plane (virtual image) can be calculated as:

$$- {y}_{1}^{′} = {β}_{1} ( 0.5 * {W}_{AA} + {d}_{1} ) \qquad Eq . 18$$

Substituting Eq. 9 can get:

$$- {y}_{1}^{′} = \frac{{f}_{1}^{′}}{{f}_{1}^{′} + {l}_{1}} ( \frac{aW}{2 \sqrt{{L}^{2} + {W}^{2}}} + {d}_{1} ) \qquad Eq . 19$$

In the second imaging, it is assumed that the optical axis of the lens is raised by d₂ relative to the optical axis of the Fresnel lens. In the first imaging, the intermediate plane is regarded as a virtual image; in the second imaging, the intermediate plane is regarded as a virtual object. Relative to the optical axis of the lens, its object height is increased by d₂, that is:

$$- {y}_{2} = \frac{{f}_{1}^{′}}{{f}_{1}^{′} + {l}_{1}} ( \frac{aW}{2 \sqrt{{L}^{2} + {W}^{2}}} + {d}_{1} ) + {d}_{2} \qquad Eq . 20$$

The image height of the second imaging is:

$${y}_{2}^{′} = {β}_{2} {y}_{2} \qquad Eq . 21$$

Substituting Eq. 11 and Eq. 20 can get:

$${y}_{2}^{′} = b ( \frac{W}{2 \sqrt{{L}^{2} + {W}^{2}}} + \frac{{d}_{1}}{a} + \frac{{d}_{2} ( {f}_{1}^{′} + {l}_{1} )}{{af}_{1}^{′}} ) \qquad Eq . 22$$

Eq. 22 represents the distance between the highest point of the picture and the optical axis. It can be known from FIG. 4 or FIG. 36 that the value minus the half-height of the projected picture is Offset, that is:

$$Offset = {y}_{2}^{′} - \frac{h}{2} \qquad Eq . 23$$

Therefore, the off-axis ratio is calculated as:

$$Par . = \frac{Offset}{h / 2} = \frac{2 {y}_{2}^{′}}{h} - 1 \qquad Eq . 24$$

Substituting Eq. 14 and Eq. 220 can get:

$$Par . = \frac{2 \sqrt{{L}^{2} + {W}^{2}}}{a W} ( {d}_{1} + \frac{{d}_{2} ( {f}_{1}^{′} + {l}_{1} )}{{f}_{1}^{′}} ) \qquad Eq . 25$$

At this time, the equations for calculating the off-axis ratio of the Fresnel lens that is eccentric or non-eccentric can be generalized. Specifically, when d₁=0, i.e., the Fresnel lens is not eccentric, and d₂=h₁, Eq. 25 can be simplified to Eq. 15, and thus Eq. 25 is a general expression. In the simulation of the present disclosure, assuming d₁=6 mm and d₂=7.85 mm, the off-axis ratio can be calculated as Par.=47.72% according to Eq. 25.

In particular, when the Fresnel lens and the projection lens are coaxial, and the raised height relative to the normal line of the LCD's center is 13.85 mm, d₁=13.85 mm, d₂=0 mm, and the off-axis ratio is calculated as Par.=49.99%.

Here, it can be seen that the special meaning of 13.85 mm is ¼ of the width of the display area. It can be concluded that when the Fresnel lens and the lens are coaxial, the optical axis only needs to be raised by ¼ of the width of the display area relative to the normal line of the center of the display area to achieve a 50% off-axis ratio.

Typically, the eccentricity of a common Fresnel lens is 0-8 mm. However, if there is a larger Fresnel lens eccentricity, the manufacturer can also match it. For example, the manufacturer can provide Fresnel lenses with eccentricity up to 13.85 mm, or even larger eccentricity. Optionally, in some embodiments, the optical axis of the first lens is arranged parallel to the system optical axis with a distance therefrom, and both the optical axis of the first lens and the optical axis of the projection lens are located on the same side of the system optical axis.

Optionally, in some embodiments, the optical axis of the projection lens, the optical axis of the first lens, and the system optical axis are located on the same plane; the distance between the optical axis of the projection lens and the system optical axis is greater than or equal to the distance from the optical axis of the first lens to the system optical axis.

Optionally, in some embodiments, the off-axis ratio of the projected picture is

$$Par . 2 = \frac{2 \sqrt{{L}^{2} + {W}^{2}}}{a W} ( {d}_{1} + \frac{{d}_{2} ( {f}_{1}^{′} + {l}_{1} )}{{f}_{1}^{′}} ) ,$$

wherein d₁ is the distance between the optical axis of the first lens and the system optical axis, d₂ is a difference between the distance of the optical axis of the projection lens and the system optical axis and the distance of the optical axis of the first lens and the system optical axis, f′₁ is an image-side focal length of the first lens, −l₁ is an object distance of the display panel relative to the first lens, L is the length of a projected picture, W is the width of the projected picture, a is a size of a diagonal line of the display area of the display panel. It should be noted that L and W are measured when the plane where the projected picture is located is perpendicular to the system optical axis. It should be noted that the off-axis ratio of the projected picture of an actual product may fluctuate by 10% compared with Par.2. It can be considered that when the difference (absolute value) between the off-axis ratio of the projected picture of an actual product and the theoretical value of Par.2 is less than or equal to 10% of the Par., the actual product is also within the scope of the disclosure of the present application. The specific equation can be expressed as: the off-axis ratio of the projected picture of an actual product is

$$Par . 21 = {K}_{2} \times \frac{2 \sqrt{{L}^{2} + {W}^{2}}}{a W} ( {d}_{1} + \frac{{d}_{2} ( {f}_{1}^{′} + {l}_{1} )}{{f}_{1}^{′}} ) ,$$

wherein the value range of K₂ is 0.9-1.1. Optionally, the value range of K₂ can be controlled within 0.95-1.05.

In some embodiments, d₁ is in the range of −0.5 W_{AA}-0.5 W_{AA}, d₂ is in the range of −0.5 W_{AA}-0.5 W_{AA}, and the signs of d₁ and d₂ are the same, wherein W_{AA} is the width of the display panel. Optionally, in some embodiments, d₁ is in the range of −0.3 W_{AA}-0.3 W_{AA}, and d₂ is in the range of −0.3 W_{AA}-0.3 W_{AA}. When d₁ is in the range of −0.25 W_{AA}-0.25 W_{AA}, a good off-axis projection of 0˜50% can be achieved. When d₁ is outside the range of −0.3 W_{AA}-0.3 W_{AA}, the imaging quality may be reduced, especially when d₁ is greater than 0.3 W_{AA}, the display may be blurred, and the brightness and uniformity may be reduced.

Optionally, in some embodiments, d₁ is in the range of −0.5 W_{AA}-0.5 W_{AA}, d₂=0 mm, wherein W_{AA} is the width of the display panel. Optionally, in some embodiments, d₁ is in the range of −0.3 W_{AA}-0.3 W_{AA}, and d₂₌₀ mm.

Optionally, in some embodiments, d₁ is in the range of 2-8 mm.

It can be seen that compared with only raising the projection lens, the raising displacement of the projection lens in this off-axis solution is not much different, and the position of the projection lens does not change much. When the front Fresnel lens is eccentric, the oblique illumination angle will be changed. For details, please refer to the description in Supplementary Table 2. The main function of the lighting system is to increase the light utilization rate and improve the uniformity. Although it does not affect the object-image relationship (referring to the description relating to FIG. 7, after the Fresnel lens is eccentric, the base point planes of the optical groups 1 and 2 do not change, and the magnification does not change), the lighting system needs to be matched with the imaging system to form the object-side telecentric optical path.

The advantage of this off-axis solution is that even in the absence of oblique illumination, the intersection point where parallel rays converge is closer to the center of the aperture diaphragm, which is beneficial to the improvement of brightness and uniformity.

The specific eccentricity of the front Fresnel lens and improved efficiency are related to various structural parameters, such as oblique illumination angle, off-axis ratio, and so on. The typical value range is between 0 and 6 mm, and the specific value is selected based on the best simulation result. The above listed analytic equations are universal.

Generally speaking, the oblique illumination angle should be as small as possible. Because the oblique illumination angle is too large, the focusing performance of the Fresnel lens will be deteriorated, destroying the conditions of the telecentric optical path (the oblique illumination angle is required to be less than) 10°. In addition, the essence of oblique illumination is to use the rays with a large aperture angle to form an image, and thus the aberration may also increase (the oblique illumination angle is required to be less than) 5°.

The following is the derivation of the equation for an oblique illumination angle. The purpose of oblique illumination is to make the ray in the main direction pass through the LCD, the front Fresnel lens, and the lens piece of the lens before the aperture diaphragm, and reach the center of the aperture diaphragm, which is referred to as the “chief ray” at this time.

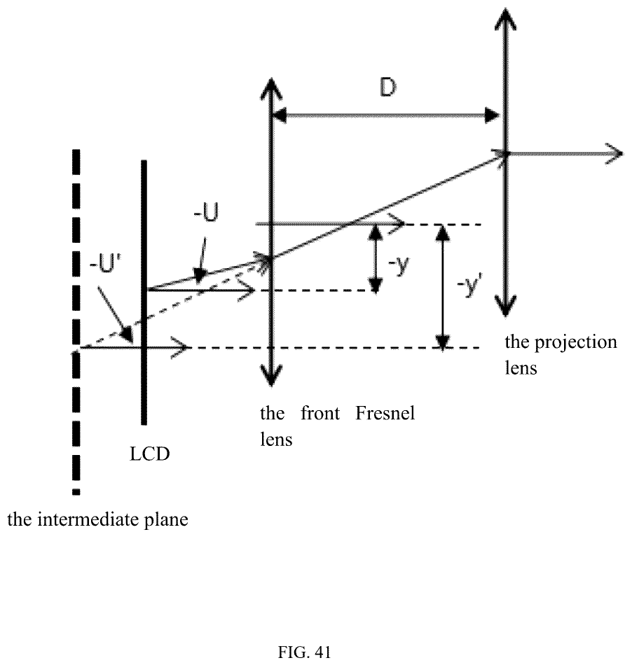

To abstract and simplify the problem, it can be described as: the ray from the center of the display area, with an aperture angle −U, can pass through the center of the lens after passing through the front Fresnel lens. Now solve the aperture angle −U. At this time, the oblique illumination angle of the lighting system is −U, that is, −A₁=−U. At this time, the chief ray passes through the center of the aperture diaphragm, forming the object-side telecentric optical path. The light transmission rate is the largest. FIG. 41 shows the schematic diagram of calculating an oblique illumination angle.

Here, it is assumed that the front Fresnel lens has an eccentricity d₁ (the eccentric direction is consistent with the off-axis direction of the lens), and the lens has an eccentricity d₂ relative to the optical axis of the front Fresnel lens. At this time, the object height of the center of the display area relative to the optical axis of the front Fresnel lens is −y, and the image height is −y′, then:

$$tan ( - {U}^{′} ) \approx \frac{[ {d}_{1} - ( - {l}_{1} ) tan ( - U ) ] + {d}_{2}}{D} \qquad Eq . 26$$

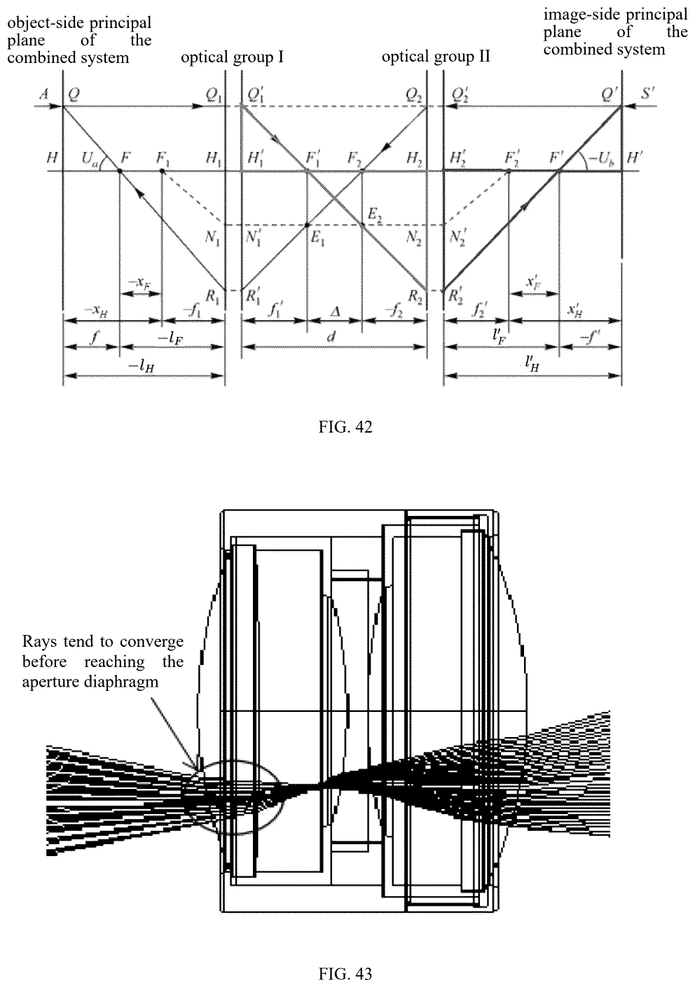

FIG. 42 shows the schematic diagram of an ideal two-optical group imaging, wherein D is the spatial distance (d in FIG. 42) between H_{1′} of optical group 1 and H₂ of optical group 2. Generally, this value needs to be read and calculated from the lens design parameters. Here, an ideal model is adopted for analysis, and the front Fresnel lens and the lens are regarded as thin lenses, and D is the distance between their optical centers. The symbol of approximately equal to is used here, which means that it is calculated in an ideal way, ignoring the influence of the thickness of an optical group.

Within the scope of imaging specifications, it can generally be regarded as an ideal imaging system, then there are:

$$ny tan U = {n}^{′} {y}^{′} tan {U}^{′} \qquad Eq . 27$$

This is the Lagrange-Helmholtz invariants equation for an ideal optical system. Here n=n′ ≈1. Here, −y means the object height, and its value can be arbitrary, for example: −y=d1. The optical path allows the case of d₁=0. However, −y≠0 will be considered in the analysis, so as to avoid 0 values on both sides of the above equation. So there is:

$$tan ( - U ) = {β}_{1} tan ( - {U}^{′} ) \qquad Eq . 28$$

wherein:

$${β}_{1} = \frac{{f}_{1}^{′}}{{f}_{1}^{′} + {l}_{1}} \qquad Eq . 29$$

According to Eq. 9, Eq. 26 and Eq.29, there is:

$$tan ( - U ) = \frac{{d}_{1} + {d}_{2}}{- {l}_{1} + D + {Dl}_{1} / {f}_{1}^{′}} \qquad Eq . 30$$

Typically, D is about the same as the focal length of the front Fresnel lens. This is because the parallel light converges at the center of the lens after passing through the front Fresnel lens, forming the telecentricity at the object side. Then, the above equation can be simplified as:

$$tan ( - U ) \approx \frac{{d}_{1} + {d}_{2}}{{f}_{1}^{′}} \qquad Eq . 31$$

$$- {A}_{1} = arc tan ( \frac{{d}_{1} + {d}_{2}}{{f}_{1}^{′}} ) \qquad Eq . 32$$

In the above embodiments, d₁ may be 0, which means that the optical axis of the first lens coincides with the system optical axis, that is, there is no translation of the first lens relative to the system optical axis.

As shown in FIG. 43, an actual lens cannot be considered a thin lens in FIG. 43. Before the rays reach the center of the aperture diaphragm, they need to be refracted by lens interfaces many times, and they tend to converge, which means that the rays can converge to the center of the aperture diaphragm at a smaller oblique angle. Therefore, the absolute value of the first angle of an actual product may be equal to or smaller than the absolute value of −A₁, and the difference from the absolute value of −A₁ is within 3°. It can be considered that when the difference between the absolute value of the first angle of an actual product and the absolute value of −A₁ is less than or equal to 3°, the actual product is also within the scope of the disclosure of the present application.

The eccentricity of the front Fresnel lens: the eccentricity of the front Fresnel lens should not be too large. When the off-axis amount of the front Fresnel lens is too large, it is equivalent to the excessive downward movement of the LCD, the center of the LCD is farther from the optical axis, severe vignetting may occur at this time, and the uniformity of the projected picture may decrease (compared with FIG. 26), the brightness may also drop (compared with FIG. 28). Therefore, in the embodiments of the present disclosure, the eccentricity of the front Fresnel lens is set as 4-8 mm, which is an optimized result after simulation. When the eccentricity of the front Fresnel lens is 13.85 mm (perpendicular illumination), the uniformity of the projected picture is not good, and the received luminous flux of the projected picture at this time is 189 Lm.

FIG. 37 shows a model in which the conditions include perpendicular illumination and a 6 mm eccentricity of the front Fresnel lens. As shown in FIG. 37, observing the intersection point of the front Fresnel lens by using the parallel light with an aperture angle A₁=0°, it can be seen that it is still deviated from the center of the aperture diaphragm. Therefore, there is an angle between the main direction A₁=0° of the illumination optical path and the chief ray of the imaging optical path, that is, they are not strictly matched, which may lead to a decrease in light efficiency, and the peak of the light spot on the screen is not at the center. In this model, the peak illuminance on the screen is still relatively low (compared to FIG. 27), but the difference is not very apparent; the luminous flux received on the screen is 188.4 Lm, which is 6.6% lower than 201.8 Lm in FIG. 28, but it is also within the product specifications. It is also possible to use a light source with higher light efficiency, paste ESR on the reflecting mirror or coat the Fresnel lens, to increase the brightness to about 220 Lm.

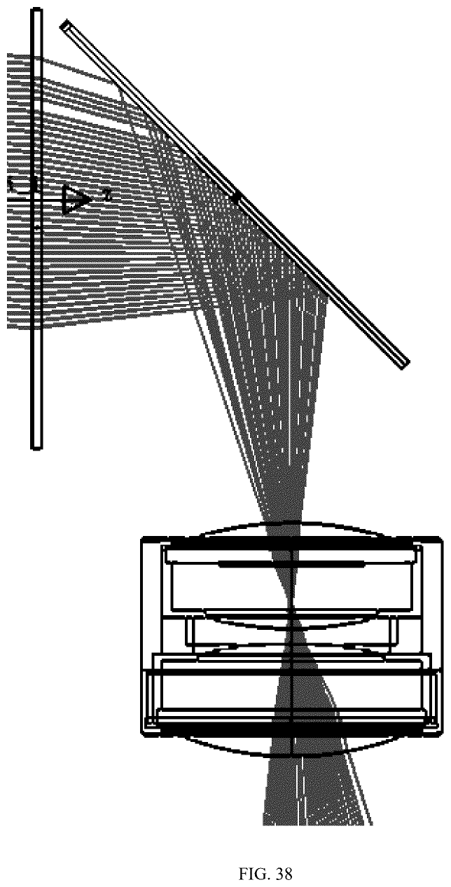

FIG. 38 shows another model, the conditions of which include oblique illumination of 2.7° and an eccentricity of 6 mm for the front Fresnel lens. From the parallel light test, this angle only needs 2.7° to satisfy the telecentricity at the object space, as shown in FIG. 38. The possible factors for the difference between them are: the spectral distribution of light, the influence of the lens piece, the measurement and fitting deviation in FIG. 32, and so on.

From the principle of off-axis described hereinbefore, this off-axis solution is essentially equivalent to an increase in the object height of imaging. The maximum object height of imaging without off-axis is: the diagonal line of the display area, that is, R_{1MAX}=4.45*25.4/2=56.515 mm.

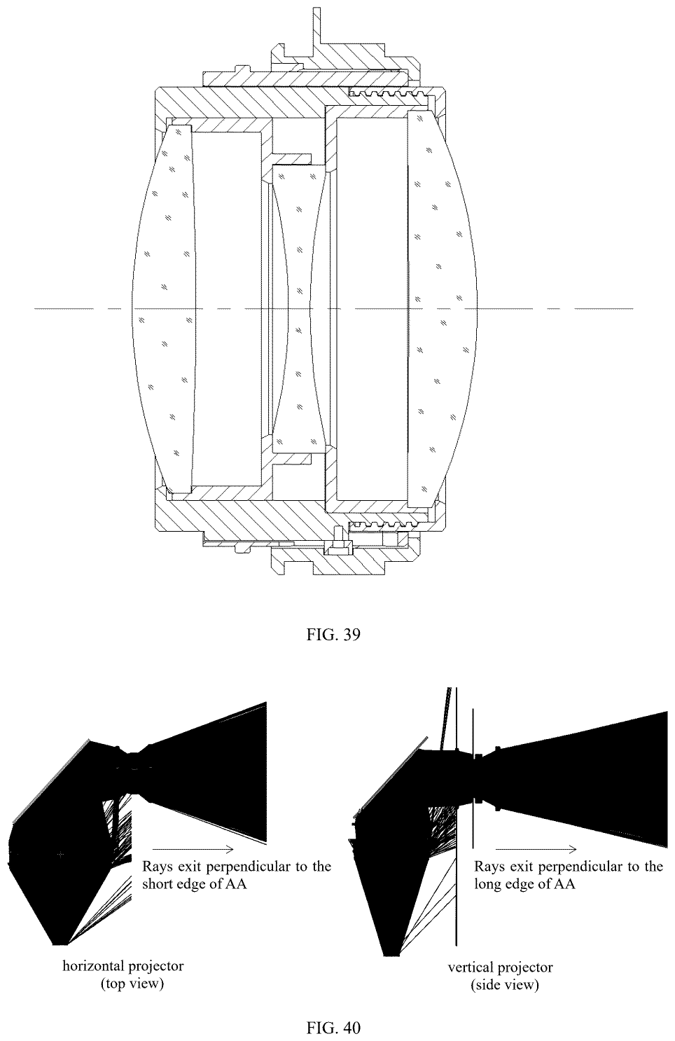

When the off-axis is 50%, the center of the LCD is equivalent to moving downward by W_{AA}/4=13.85 mm. At this time, a new display area is formed with the length and width being about: 98.5*83.1, and the maximum image height becomes: R_{2MAX}=sqrt (98.5\hat{ }2+83.1\hat{ }2)/2=64.4 mm. At this time, the 4.45-inch panel is equivalent to a 5.07-inch panel. FIG. 39 is a schematic diagram of the structure of the lens applicable to the embodiments of the present disclosure.

The technical solutions disclosed in the present disclosure can be applied not only to a vertical projector, but also to a horizontal projector. The only difference between a horizontal projector and a vertical projector is the direction in which the reflecting mirror is placed. As shown in FIG. 40, in a horizontal projector, the rays are emitted perpendicular to the short edge of the display area; in a vertical projector, the rays are emitted perpendicular to the long edge of the display area.

Optionally, in some embodiments, as shown in FIG. 7 and FIG. 13, the light source includes a light emitting element and a second lens (that is, a rear Fresnel lens) located at the light emitting side of the light emitting element.

Optionally, as shown in FIG. 8, in some embodiments, the projector further includes: a first reflecting mirror (that is, an illumination reflecting mirror), the first reflecting mirror is located between the light source and the first lens and configured to reflect the rays from the light source to the first lens.

Optionally, in some embodiments, the first reflecting mirror has a trapezoidal shape, the short edge of the trapezoidal shape is located at the side of the first reflecting mirror close to the light source, and the long edge of the trapezoidal shape is located at the side of the first reflecting mirror away from the light source. Optionally, the distance between the short edge and the long edge is greater than the length of the long edge.

Optionally, as shown in FIG. 8, in some embodiments, the projector further includes: a second reflecting mirror (that is, an imaging reflecting mirror), the second reflecting mirror is located between the first lens and the projection lens and configured to reflect the rays from the first lens to the projection lens.

Optionally, in some embodiments, the second reflecting mirror has a trapezoidal shape, the short edge of the trapezoidal shape is located on the side of the second reflecting mirror close to the first lens, and the long edge of the trapezoidal shape is located on the side of the second reflecting mirror away from the first lens. Optionally, the distance between the short edge and the long edge is greater than the length of the long edge.

In the context of the present disclosure, the “shape” of a reflecting mirror refers to the shape of the outer contour of the reflecting surface of the mirror surface of the reflecting mirror. Specifically, the surface type of the reflecting film of the reflecting mirror may be a plane. A reflecting mirror can be used in the optical path of a projector to reduce the volume of the projector. In addition, for a reflecting mirror, the light beam from a light source typically has an incident angle of, for example, approximately 45°, then the width of the reflecting mirror illuminated by the light beam at the end close to the light source is generally smaller than the width of the reflecting mirror illuminated by the light beam at the end far away from the light source. Therefore, using a trapezoidal reflecting mirror can reduce the volume of a projector more effectively.

In the description of the present disclosure, the orientation or positional relationships indicated by the terms “upper”, “lower” and the like are based on the orientation or positional relationships shown in the drawings, and are only for the convenience of describing the present disclosure, instead of requiring that the present disclosure must be constructed and operated according to particular orientations, and therefore should not be construed as limiting of the present disclosure.

In the description of this specification, descriptions with reference to the terms “one embodiment”, “another embodiment” and the like mean that the specific feature, structure, material or characteristic described in connection with the embodiment is included in at least one embodiment of the present disclosure. In this specification, the schematic representations of the above terms are not necessarily directed to the same embodiment or example. Furthermore, the described specific feature, structure, material or characteristic may be combined in any suitable manner into any one or more embodiments or examples. In addition, those having ordinary skills in the art can combine and assemble different embodiments or examples as well as features of different embodiments or examples described in this specification without conflicting with each other. In addition, it should be noted that in this specification, the terms “first” and “second” are used for description purposes only, and cannot be understood as indicating or implying relative importance or implicitly indicating the quantity of indicated technical features.

The above description is only for specific implementation manners of the present disclosure, but the protection scope of the present disclosure is not limited thereto. Any changes or substitutions that can be easily conceived by those having ordinary skills in the art within the technical scope disclosed in the present disclosure shall fall within the protection scope of the present disclosure. Therefore, the protection scope of the present disclosure should be determined by the protection scopes of the claims.

1. A projector, comprising a light source, a display panel, a first lens, and a projection lens;
wherein the projector is configured such that the light emitted by the light source can sequentially pass through the display panel, the first lens, the projection lens and then exit;
wherein, the projector comprises a system optical axis, and a normal line of a center of a display area of the display panel coincides with the system optical axis, an optical axis of the projection lens is arranged parallel to the system optical axis with a distance therefrom.

2. The projector according to claim 1, wherein a center of the projection lens is located at a first position, the system optical axis comprises a second position, and a connecting line of the first position and the second position is perpendicular to the system optical axis, wherein a position of the projection lens is configured such that when the center of the projection lens moves from the second position to the first position, a connecting straight line from a center of a projected picture to the center of the projection lens coincides with the system optical axis.

3. The projector according to claim 1, wherein a distance from a center of a projected picture to the system optical axis is linearly correlated to a distance from the projected picture to the projection lens.

4. The projector according to claim 1, wherein an optical axis of the first lens coincides with the system optical axis;
off-axis ratio of a projected picture is
$$Par . 1 = \frac{2 {h}_{1} ( {f}_{1}^{′} + {l}_{1} ) \sqrt{{L}^{2} + {W}^{2}}}{{af}_{1}^{′} W} ,$$
wherein h₁ is the distance between the optical axis of the projection lens and the system optical axis, f′₁ is an image-side focal length of the first lens, −l₁ is an object distance of the display panel relative to the first lens, L is a length of a projected picture, W is a width of the projected picture, and a is a size of a diagonal line of the display area of the display panel.

5. The projector according to claim 1, wherein an optical axis of the first lens is arranged parallel to the system optical axis with a distance therefrom, and the optical axis of the first lens and the optical axis of the projection lens are located on a same side of the system optical axis.

6. The projector according to claim 5, wherein the optical axis of the projection lens, the optical axis of the first lens, and the system optical axis are located on a same plane, the distance from the optical axis of the projection lens to the system optical axis is greater than or equal to the distance from the optical axis of the first lens to the system optical axis.

7. The projector according to claim 6, wherein off-axis ratio of a projected picture is
$$Par . 2 = \frac{2 \sqrt{{L}^{2} + {W}^{2}}}{a W} ( {d}_{1} + \frac{{d}_{2} ( {f}_{1}^{′} + {l}_{1} )}{{f}_{1}^{′}} ) ,$$
wherein d₁ is the distance between the optical axis of the first lens and the system optical axis,
d₂ is a difference between the distance from the optical axis of the projection lens to the system optical axis and the distance from the optical axis of the first lens to the system optical axis,
f′₁ is an image-side focal length of the first lens,
−l₁ is an object distance of the display panel relative to the first lens,
L is a length of a projected picture,
W is a width of the projected picture,
α is a size of a diagonal line of a display area of the display panel.

8. The projector according to claim 3, wherein h₁ is in a range from −0.3 W_{AA} to 0.3 W_{AA}, wherein W_{AA} is a width of the display panel.

9. The projector according to claim 7, wherein d₁ is in a range from −0.3 W_{AA} to 0.3 W_{AA}, d₂ is in a range from −0.3 W_{AA} to 0.3 W_{AA}, and signs of d₁ and d₂ are the same, wherein W_{AA} is a width of the display panel.

10. The projector according to claim 7, wherein d₁ is in a range from −0.3 W_{AA} to 0.3 W_{AA}, d₂=0 mm, wherein W_{AA} is a width of the display panel.

11. The projector according to claim 7, wherein d₁ is in a range from 2 mm to 8 mm.

12. The projector according to claim 1, wherein an optical axis of the light source and the system optical axis form a first angle that is non-zero;
the light source is configured such that light propagating along the optical axis of the light source is emitted from a first side of the system optical axis to a second side of the system optical axis;
wherein a plane in which the optical axis of the light source and the system optical axis are co-located and a plane in which the system optical axis and the optical axis of the projection lens are co-located are a same plane, and the first side and the second side are respectively two sides of the system optical axis, and the second side is a side where the optical axis of the projection lens is located.

13. The projector according to claim 12, wherein the first angle is −A₁=arctan ((d₁+d₂)/f′₁), wherein d₁ is a distance between an optical axis of the first lens and the system optical axis, d₂ is a difference between the distance of the optical axis of the projection lens and the system optical axis and the distance of the optical axis of the first lens and the system optical axis, f′₁ is an image-side focal length of the first lens, and −l₁ is an object distance of the display panel relative to the first lens.

14. The projector according to claim 13, wherein light beams emitted by the light source intersect at a first intersection point after passing through the first lens, and a shortest distance between the first intersection point and the system optical axis has a linear relationship with the first angle, and the shortest distance between the first intersection point and the system optical axis increases as the first angle increases.

15. The projector according to claim 12, wherein an angle between a light beam propagation direction along the optical axis of the light source and the system optical axis is in a range from 2° to 7°.

16. The projector according to claim 12, wherein the light emitted by the light source is a collimated light beam.

17.-18. (canceled)

19. The projector according to claim 1, wherein the first lens is a Fresnel lens, the first lens comprises a textured surface with a texture center, the textured surface faces the display panel, and the textured surface is parallel to an extension plane of the display panel; the system optical axis intersects the first lens at a geometric center of the textured surface, and the optical axis of the first lens passes through the texture center; the texture center does not coincide with the geometric center.

20. The projector according to claim 19, wherein a distance between the texture center and the geometric center is in a range from 2 mm to 8 mm.

21-22. (canceled)

23. The projector according to claim 1, wherein the display panel is a transparent liquid crystal display panel.

24. (canceled)

25. The projector according to claim 1, further comprising:
a first reflecting mirror located between the light source and the first lens and configured to reflect light from the light source to the first lens;
a second reflecting mirror located between the first lens and the projection lens and configured to reflect light from the first lens to the projection lens.

26.-28. (canceled)
